(19) United States
(12) Patent Application Publication
(10) Pub. No.: US 2020/0081358 A1
(43) Pub. Date: Mar. 12, 2020

(54) ELECTROPHOTOGRAPHIC PHOTORECEPTOR, IMAGE FORMING METHOD, AND IMAGE FORMING APPARATUS

(71) Applicant: Konica Minolta, Inc., Tokyo (JP)

(72) Inventors: Hiroki TAKAO, Tokyo (JP); Tomoko SAKIMURA, Tokyo (JP); Mayuko MATSUSAKI, Tokyo (JP); Kengo IKEDA, Kitamono-shi (JP)

(21) Appl. No.: 16/542,412

(22) Filed: Aug. 16, 2019

(30) Foreign Application Priority Data
Sep. 7, 2018 (JP) 2018-167961

(51) Int. Cl. G03G 5/147; G03G 5/10; G03G 5/06; G03G 21/00

(52) U.S. Cl. CPC G03G 5/14704; G03G 5/102; G03G 21/0005; G03G 5/0614; G03G 21/0094; G03G 5/0696

(57) ABSTRACT

The electrophotographic photoreceptor includes a conductive support, a photosensitive layer disposed on the conductive support, and an outermost layer disposed on the photosensitive layer, in which the outermost layer includes a cured product of a composition containing a polymerizable monomer and two or more kinds of conductive metal oxide particles having different number average primary particle diameters from each other, and at least one of the two or more kinds of conductive metal oxide particles is surface-treated with a surface treating agent having a silicone chain as a side chain.

### CROSS-REFERENCE TO RELATED APPLICATION

The entire disclosure of Japanese Patent Application No. 2018-167961, filed on Sep. 7, 2018, is incorporated herein by reference in its entirety.

### BACKGROUND

### 1. Technical Field

The present invention relates to an electrophotographic photoreceptor, an image forming method, and an image forming apparatus.

### 2. Description of Related Arts

An electrophotographic image forming apparatus includes an electrophotographic photoreceptor (hereinafter, simply referred to as a “photoreceptor”) as a unit for forming an electrostatic latent image according to an optical signal corresponding to an image to be formed. As the photoreceptor, an organic photoreceptor containing an organic photoconductive material has been widely used, but in various processes for forming an image, such as charging, exposure, development, supply of a lubricant, transfer, cleaning, and the like, electrical energy, light energy, mechanical energy, and the like are supplied. Therefore, there is a demand for the photoreceptor that charging stability, potential retainability, or the like does not deteriorate even when image forming is repeatedly performed. In regard to such a demand, a technology in which a protective layer including organic particles is provided on a surface of the photoreceptor has been known.

Furthermore, in recent years, a spherical toner with a fine particle diameter has been mainstream in accordance with an increase in a demand for an image with a high definition and a high image quality. Adhesion of the spherical toner with a fine particle diameter to a surface of the photoreceptor is strong and removal of the remaining toner such as a transfer residual toner adhering to the surface, or the like is likely to be insufficient. In a cleaning method using a rubber plate, slipping of a toner easily occurs, and in order to solve such as problem, there is a need to increase an abutting pressure applied to a photoreceptor of the plate, in this case, however, a problem that a repetitive use causes wear of a surface of the photoreceptor and durability is insufficient occurs.

As a technology which improves durability (wear resistance) and cleanability of a photoreceptor, for example, JP 2012-123238 A discloses an electrophotographic photoreceptor containing a compound (A) having seven or more polymerizable functional groups, a compound (B) having two to four polymerizable functional groups, and surface-treated metal oxide fine particles which are surface-treated with a surface treating agent having a polymerizable functional group. Further, JP 2002-351114 A (US 2003/0,104,295 A) discloses an electrophotographic photoreceptor in which a protective layer contains at least two kinds of insulating fillers having different volume-averaged particle diameters from each other, and a particle diameter distribution of the insulating filler in the protective layer has a particle diameter distribution inclination indicating that the particle diameter continuously increases from a photosensitive layer side toward a surface side.

### SUMMARY

However, in the technologies disclosed in JP 2012-123238 A and JP 2002-351114 (US 2003/0,104,295 A) described above, there is a problem that an effect of improving wear resistance or cleanability of a photoreceptor is still insufficient.

Furthermore, the electrophotographic image forming apparatus is required to cope with an increase in printing speed (the number of printouts per hour). In order to increase the printing speed, it is required to increase a line speed of the image forming apparatus, and therefore, there is a need to secure developability by increasing a rotational speed of the photoreceptor and, at the same time, increasing a rotational speed of a developing sleeve of a developing machine. However, in a case of increasing the rotational speed of the photoreceptor and the rotational speed of the developing sleeve, scattering of the toner easily occurs, and thus a part of the scattered toner adheres to a surface of the photoreceptor, and as a result, fogging (background fogging) occurs in an image, which causes image quality deterioration. The technologies disclosed in JP 2012-123238 A and JP 2002-351114 (US 2003/0,104,295 A) described above also has a problem that an effect of suppressing such a fogging is insufficient.

In this regard, an object of the present invention is to provide means for improving wear resistance and cleanability of an electrophotographic photoreceptor and suppressing fogging.

The present inventors have intensively researched. As a result, the present inventors found out that the problems described above are solved by an electrophotographic photoreceptor described below and completed the present invention.

An electrophotographic photoreceptor reflecting one aspect of the present invention in order to realize at least one of the objects described above is an electrophotographic photoreceptor used in an image forming method including a charging process of charging a surface of the electrophotographic photoreceptor, an exposing process of exposing the charged electrophotographic photoreceptor to form an electrostatic latent image, a developing process of supplying a toner to the electrophotographic photoreceptor on which the electrostatic latent image is formed to form a toner image, a transfer process of transferring the toner image formed on the electrophotographic photoreceptor, a lubricant supply process of supplying a lubricant to the surface of the electrophotographic photoreceptor, and a cleaning process of removing the toner remaining on the surface of the electrophotographic photoreceptor, and the electrophotographic photoreceptor includes: a conductive support; a photosensitive layer disposed on the conductive support; and an outermost layer disposed on the photosensitive layer, wherein the outermost layer includes a cured product of a composition containing a polymerizable monomer and two or more kinds of conductive metal oxide particles having different number average primary particle diameters from each other, and at least one of the two or more kinds of conductive metal oxide particles is surface-treated with a surface treating agent having a silicone chain as a side chain.

### BRIEF DESCRIPTION OF THE DRAWINGS

The advantages and characteristics provided by one or more embodiments of the present invention can be more sufficiently understood by the following detailed description and the accompanying drawings. It should be noted that the drawings are provided only for illustrative purpose and are not intended to define the scope of the present invention.

FIG. 1 is a schematic configuration view illustrating an image forming apparatus according to an embodiment of the present invention. In FIG. 1, reference numerals 1Y, 1M, 1C, and 1Bk each represent an electrophotographic photoreceptor, reference numerals 2Y, 2M, 2C, and 2Bk each represent a charging unit, reference numerals 3Y, 3M, 3C, and 3Bk each represent an exposing unit, reference numerals 4Y, 4M, 4C, and 4Bk each represent a developing unit, reference numerals 5Y, 5M, 5C, and 5Bk each represent a primary transfer roller (primary transfer unit), a reference numeral 5b represents a secondary transfer portion (secondary transfer unit), reference numerals 6Y, 6M, 6C, 6Bk, and 6b each represent a cleaning unit, a reference numeral 7 represents an intermediate transfer body unit, a reference numeral 8 represents a housing, reference numerals 10Y, 10M, 10C, and 10Bk each represent an image forming unit, a reference numeral 20 represents a paper feed cassette, a reference numeral 21 represents a paper feed unit, reference numerals 22A, 22B, 22C, and 22D each represent an intermediate roller, a reference numeral 23 represents a resist roller, a reference numeral 24 represents a fixing unit, a reference numeral 25 represents a paper discharge roller, a reference numeral 26 represents a paper discharge tray, a reference numeral 70 represents an intermediate transfer body, reference numerals 71, 72, 73, and 74 each represent a roller, reference numerals 82R and 82L each represent a support rail, a reference numeral 100 represents an image forming apparatus, a reference numeral A represents a main body, a reference numeral P represents a paper, and a reference numeral SC represents a document image reading device.

FIG. 2 is a schematic configuration diagram illustrating an example of a lubricant supply unit included in the image forming apparatus according to the embodiment of the present invention. In FIG. 2, a reference numeral 1Y represents an electrophotographic photoreceptor, a reference numeral 2Y represents a charging unit, a reference numeral 5Y represents a primary transfer roller (primary transfer unit), a reference numeral 6Y represents a cleaning unit, a reference numeral 116Y represents a lubricant supply unit, a reference numeral 120 represents a housing, a reference numeral 121 represents a brush roller, a reference numeral 122 represents a lubricant, a reference numeral 122a represents a surface, and a reference numeral 123 represents a pressurizing spring.

FIG. 3 is a schematic configuration diagram illustrating an example of a preparation apparatus used to prepare a composite particle (core-shell particle). In FIG. 3, a reference numeral 41 represents a mother-liquor tank, a reference numeral 41a represents a stirring blade, reference numerals 41b and 43b each represent a shaft, reference numerals 41c and 43c each represent a motor, reference numerals 42 and 44 each represent a circulating pipe, a reference numeral 43 represents a strong dispersion device, a reference numeral 43a represents a stirring unit, and reference numerals 45 and 46 each represent a pump.

### DETAILED DESCRIPTION OF THE EMBODIMENT

Hereinafter, one or more embodiments of the present invention will be described with reference to the drawings. However, the scope of the invention is not limited to the disclosed embodiments. In the description of the drawings, the same elements are denoted by the same reference numerals, and redundant description is omitted. In addition, in some cases, dimensional ratios in the drawings are exaggerated and different from actual ratios for convenience of the description.

In the present specification, unless otherwise specified, operations and measurements of physical properties or the like are performed under conditions of room temperature (20° C. or more and 25° C. or less) and relative humidity of 40% RH or more and 50% RH or less.

### [Electrophotographic Photoreceptor]

An electrophotographic photoreceptor according to an embodiment of the present invention is used in an image forming method including a charging process of charging a surface of the electrophotographic photoreceptor, an exposing process of exposing the charged electrophotographic photoreceptor to form an electrostatic latent image, a developing process of supplying a toner to the electrophotographic photoreceptor on which the electrostatic latent image is formed to form a toner image, a transfer process of transferring the toner image formed on the electrophotographic photoreceptor, a lubricant supply process of supplying a lubricant to the surface of the electrophotographic photoreceptor, and a cleaning process of removing the toner remaining on the surface of the electrophotographic photoreceptor. Further, the electrophotographic photoreceptor includes a conductive support, a photosensitive layer disposed on the conductive support, and an outermost layer disposed on the photosensitive layer, in which the outermost layer includes a cured product of a composition containing a polymerizable monomer and two or more kinds of conductive metal oxide particles having different number average primary particle diameters from each other, and at least one of the two or more kinds of conductive metal oxide particles is surface-treated with a surface treating agent having a silicone chain as a side chain.

The reason why the effects described above can be achieved by the electrophotographic photoreceptor according to the present embodiment, that is, a development mechanism and an action mechanism of the effects remain unclear, but it is speculated as follows.

In an electrophotographic image forming apparatus, generally, a negatively charged toner, and a photoreceptor of which polarity of a surface charged in the charging process is negative similarly to the toner, are used. Further, the charged toner adheres to a portion where an absolute value of a potential is decreased from a surface potential (V0) of the surface of the photoreceptor charged in the charging process due to image exposure, such that visualization (development) is made. Here, when the photoreceptor and the toner come into contact with each other, scratching between the photoreceptor and the toner occurs and thus triboelectric charging occurs. At this time, since the charging occurs so as to decrease the absolute value of the surface potential (V0) of the photoreceptor, even in a dark place (even in a state of no image exposure), the surface potential of the photoreceptor becomes lower than the surface potential (V0) when the photoreceptor is charged in the charging process. Due to the decrease in the absolute value of the surface potential (V0) of the photoreceptor, a repulsive force between the toner and the surface of the photoreceptor is decreased and thus the toner easily adheres to the surface of the photoreceptor, such that fogging caused by the toner adhering to a portion other than an exposed portion of the surface of the photoreceptor occurs. Particularly, in a high-speed electrophotographic image forming apparatus, rotational speeds of the photoreceptor and a developing sleeve are high, a scratching force applied between the surface of the photoreceptor and the toner is increased, and an effect of triboelectric charging caused by scratching becomes significant, and thus it is considered that the fogging becomes worse.

A silicone material such as the surface treating agent having a silicone chain as a side chain, or the like used in the present embodiment has negative chargeability similarly to the toner in the triboelectric series. For this reason, the conductive metal oxide particles surface-treated with the surface treating agent having a silicone chain as a side chain are added to the outermost layer of the photoreceptor and the particles are exposed to the surface of the photoreceptor, thereby suppressing the absolute value of the surface potential (V0) of the charged photoreceptor from being decreased due to scratching by the developing sleeve in an electrophotographic process. As a result, even when scattering of the toner occurs, it is difficult for the toner to adhere to the surface of the photoreceptor, such that the fogging is suppressed.

Furthermore, the surface treating agent having a silicone chain as a side chain has a bulky structure and can increase a concentration of a silicone chain on the conductive metal oxide particle after the surface treatment, such that it is possible to more efficiently perform hydrophobization of a surface of the conductive metal oxide particle. As a result, agglomeration of the conductive metal oxide particles after the surface treatment is reduced, dispersibility of the particles in the outermost layer is improved, a filler effect is efficiently achieved, and wear resistance of the surface of the photoreceptor is improved.

Furthermore, in the photoreceptor of the present embodiment, two or more kinds of conductive metal oxide particles having different number average primary particle diameters from each other are used. In a case where only the conductive metal oxide particles having a small number average primary particle diameter are used, the filler effect of increasing a strength of the surface of the photoreceptor to improve wear resistance can be achieved. However, since ruggedness of the surface of the photoreceptor is increased and contact points with the toner are increased, the toner easily adheres to the surface of the photoreceptor and rollability of the toner deteriorates, such that cleanability deteriorates. In addition, the increase of the contact points between the toner, and the conductive metal oxide particles of the surface of the photoreceptor means that injection of charges of the toner into the surface of the photoreceptor is facilitated, a potential of the surface of the photoreceptor is changed, and the fogging easily becomes worse.

Meanwhile, in a case where only the conductive metal oxide particles having a large number average primary particle diameter are used, an effect of improving the cleanability and reducing the fogging, which results from a decrease of the contact points between the toner, and the conductive metal oxide particles of the surface of the photoreceptor, can be achieved. However, since a deep scratch is easily generated on the surface of the photoreceptor and slipping of the toner easily occurs, a cleaning failure occurs.

Since the photoreceptor of the present embodiment includes two or more kinds of conductive metal oxide particles having different number average primary particle diameters from each other, it is possible to remedy the disadvantages of the case where only one kind of conductive metal oxide particles described above are used, improve wear resistance and cleanability, and achieve an effect of suppressing the fogging.

In addition, as described above, since the surface treating agent having a silicone chain as a side chain has negative chargeability in the triboelectric series, it is easy to attract and retain a positively charged lubricant. Therefore, even in a state in which an amount of lubricant supplied to the photoreceptor is decreased due to repetitive use, it is easier to achieve an effect improving cleanability and wear resistance of the surface of the photoreceptor, which results from using the lubricant.

It should be noted that the mechanism is based on speculation, and whether the speculation is true or false does not affect the technical scope of the present invention.

The electrophotographic photoreceptor is an object in which a latent image or a visible image is supported on a surface thereof in an electrophotographic image forming method. The electrophotographic photoreceptor of the present embodiment can have the same configuration as that of the photoreceptor according to the related art, except for including the outermost layer to be described later, and can be produced similarly to the photoreceptor according to the related art. Further, the outermost layer has the same configuration as that of the outermost layer according to the related art, except for having characteristics to be described later, and can be produced similarly to the outermost layer according to the related art. Portions other than the outermost layer can have the same configuration as that of portions other than the outermost layer in the photoreceptor described in JP 2012-078620 A. Further, the outermost layer can also have the same configuration as that described in JP 2012-078620 A, except that a material is different.

The electrophotographic photoreceptor of the present embodiment includes the conductive support, the photosensitive layer disposed on the conductive support, and the outermost layer disposed on the photosensitive layer. Hereinafter, the electrophotographic photoreceptor having such a configuration will be described in detail.

### (Conductive Support)

The conductive support is a member which supports the photosensitive layer and has conductivity. As preferred examples of the conductive support, a drum or sheet formed of metal, a plastic film including a laminated metal foil, a plastic film including a film of a deposited conductive material, a metal member or plastic film including a conductive layer formed by applying a paint formed of a conductive material, or a conductive material and a binder resin, a paper, and the like can be considered. As preferred examples of the metal, aluminum, copper, chromium, nickel, zinc, stainless steel, and the like can be considered, and as preferred examples of the conductive material, the metal, indium oxide, tin oxide, and the like can be considered.

### (Photosensitive Layer)

The photosensitive layer is a layer for forming an electrostatic latent image of a desired image on the surface of the photoreceptor by using the exposing unit to be described later. The photosensitive layer may be a single layer or may be configured as a plurality of laminated layers. As preferred examples of the photosensitive layer, a single layer containing a charge transport material and a charge generating material, a laminate of a charge transport layer containing the charge transport material and a charge generating layer containing the charge generating material, and the like can be considered.

### (Protective Layer)

A protective layer is a layer for improving a mechanical strength of the surface of the photoreceptor to improve scratch resistance and wear resistance. As preferred examples of the protective layer, a layer including a polymerized and cured product of a composition containing a polymerizable monomer can be considered.

### (Other Components)

The photoreceptor may further include components other than the conductive support, the photosensitive layer, and the protective layer described above. As preferred examples of other components, an intermediate layer and the like can be considered. The intermediate layer is, for example, a layer disposed between the conductive support and the sensitive layer and having a barrier function and a bonding function.

### (Outermost Layer)

In the present specification, the outermost layer of the photoreceptor represents a layer disposed at the outermost portion where the photoreceptor comes into contact with the toner. The outermost layer is not particularly limited, but it is preferable that the outermost layer is the protective layer described above. In an embodiment of the present invention, the outermost layer includes a cured product of a composition (hereinafter, also referred to as an outermost layer-forming composition) containing a polymerizable monomer and two or more kinds of conductive metal oxide particles (here, at least one of the two or more kinds of conductive metal oxide particles are surface-treated with the surface treating agent having a silicone chain as a side chain) having different number average primary particle diameters from each other.

Hereinafter, the components of the outermost layer will be described in detail.

### <Conductive Metal Oxide Particle>

The outermost layer includes a cured product of a composition (outermost layer-forming composition) containing two or more kinds of conductive metal oxide particles having different number average primary particle diameters from each other, and at least one kind of the conductive metal oxide particles is surface-treated with the surface treating agent having a silicone chain as a side chain. It is considered that the conductive metal oxide particle surface-treated with the surface treating agent having a silicone chain as a side chain is a coated particle including a surface-treating-agent-derived chemical species (coating layer) including the surface treating agent having a silicone chain as a side chain, and the conductive metal oxide particle. It should be noted that at least a portion of a surface of the surface-treated conductive metal oxide particle may include the surface-treating-agent-derived chemical species (coating layer).

Hereinafter, the surface treating agent having a silicone chain as a side chain will also be simply referred to as a “silicone surface treating agent”, surface treatment using the “silicone surface treating agent” will also be simply referred to as “silicone surface treatment”, and a conductive metal oxide particle subjected to the silicone surface treatment will also be simply referred to as a “silicone surface-treated particle”.

Further, the surface treating agent having a polymerizable group will also be simply referred to as a “reactive surface treating agent”, surface treatment using the “reactive surface treating agent” will also be simply referred to as “reactive surface treatment”, and a conductive metal oxide particle subjected to the reactive surface treatment will also be simply referred to as a “reactive surface-treated particle”.

In addition, a conductive metal oxide particle subjected to at least one of the “silicone surface treatment” and the “reactive surface treatment” will also be simply and collectively referred to as a “surface-treated particle” in some cases.

Conductive Metal Oxide Particle

In the present specification, the conductive metal oxide particle refers to a particle of which at least a surface is formed of a conductive metal oxide.

As examples of the conductive metal oxide forming the conductive metal oxide particle, although not particularly limited, magnesium oxide, zinc oxide, lead oxide, tin oxide, tantalum oxide, indium oxide, bismuth oxide, yttrium oxide, cobalt oxide, copper oxide, manganese oxide, selenium oxide, iron oxide, zirconium oxide, germanium oxide, titanium oxide, niobium oxide, molybdenum oxide, vanadium oxide, copper aluminum oxide, tin oxide doped with antimony ion, and the like can be considered. These conductive metal oxide particles can be used alone or in a combination of two or more thereof. In addition, the conductive metal oxide particle may be a synthetic product or may be a commercial product.

Among these, tin oxide (SnO₂) and titanium oxide (TiO₂) are preferable.

A lower limit value of a number average primary particle diameter of the conductive metal oxide particles is not particularly limited, but is preferably 1 nm or more, more preferably 5 nm or more, and still more preferably 10 nm or more. An upper limit value of a number average primary particle diameter of the conductive metal oxide particles is not particularly limited, but is preferably 700 nm or less, more preferably 600 nm or less, and still more preferably 500 nm or less.

It should be noted that in the present specification, the number average primary particle diameter of the conductive metal oxide particles is defined as a number average primary particle diameter measured by the following method.

First, a photograph taken by a scanning electron microscope (manufactured by JEOL Ltd.) at 10,000 magnification is put into a scanner. Next, 300 particle images except for agglomerated particle images in the obtained photograph image are randomly binarized by using LUZEX (registered trademark) AP software ver. 1.32 (manufactured by NIRECO Corporation) which is an automatic image processing analyzing system to calculate horizontal Feret diameters of the respective particle images. Then, an average value of the horizontal Feret diameters of the respective particle images is calculated as the number average primary particle diameter. Here, the horizontal Feret diameter refers to a length of a side of a circumscribed rectangle when the particle image is binarized, the side being parallel to an x axis. Further, measurement of the number average primary particle diameter of the conductive metal oxide particles is performed on conductive metal oxide particles which do not include the surface-treating-agent-derived chemical species (coating layer).

Further, in the present specification, “the outermost layer includes two or more kinds of conductive metal oxide particles having different number average primary particle diameters from each other” means that when the number average primary particle diameters of the conductive metal oxide particles included in the outermost layer are measured by the method described above and a particle diameter distribution is obtained, a multi-peak distribution with two or more peaks is shown.

The outermost layer according to the present invention includes two or more kinds of conductive metal oxide particles having different number average primary particle diameters from each other, and when a number average primary particle diameter of first conductive metal oxide particles (D1) having the smallest number average primary particle diameter is d1, and a number average primary particle diameter of second conductive metal oxide particles (D2) having the largest number average primary particle diameter is d2, a ratio of d1 to d2 (d1/d2) is preferably more than 0 and 0.7 or less, more preferably more than 0 and 0.6 or less, and still more preferably satisfies the following Expression 1.

[Math. 1]

0<d1/d2≤0.5 (1)

In a case where d1/d2 is within the above range, the effects of the use of two or more kinds of conductive metal oxide particles can be efficiently achieved.

It should be noted that a lower limit value of d1/d2 may be more than 0, 0.03 or more, 0.04 or more, 0.1 or more, or 0.2 or more.

d1 is preferably 1 nm or more and less than 50 nm, more preferably 5 nm or more and less than 50 nm, and still more preferably 10 nm or more and 40 nm or less. Further, d2 is preferably 30 nm or more and 700 nm or less, more preferably 40 nm or more and 600 nm or less, and still more preferably 50 nm or more and 500 nm or less. In a case where d1 and d2 are within the ranges, respectively, it is easy to achieve the effect of the present invention, which improves wear resistance and cleanability and suppresses the fogging.

When d1 is excessively small, cleanability deteriorates accordingly or the effect of suppressing the fogging cannot be achieved in some cases. When d2 is excessively large, dispersibility of the conductive metal oxide particles deteriorates or a curing failure due to deterioration of light transmittance of the outermost layer is caused in some cases.

Further, a mixing mass ratio of D1 to D2 (D1/D2) is not particularly limited, but is preferably 5/95 to 95/5, and more preferably 30/70 to 70/30. When the mixing mass ratio is within this range, the effects of the present invention can be more efficiently achieved.

At least one kind of the conductive metal oxide particles according to the present invention are surface-treated with the silicone surface treating agent. The silicone surface treating agent is not particularly limited, but has a silicone chain as a side chain of a polymer main chain, and preferably further has a surface treatment functional group. As the surface treatment functional group, a group which can bond to the conductive metal oxide particle, such as a carboxylic acid group, a hydroxyl group, -Rd-COOH (Rd is a divalent hydrocarbon group), an alkylsilyl group, a halogenated silyl group, an alkoxysilyl group, and the like, can be considered. Among these, a carboxylic acid group, a hydroxyl group, or an alkoxysilyl group is preferable.

The polymer main chain of the silicone surface treating agent is preferably a poly(meth)acrylate main chain or a silicone main chain and more preferably a silicone main chain. Since a conductive metal oxide particle surface-treated with a surface treating agent having silicone chains as both of a main chain and a side chain has a larger number of silicone chains, dispersibility in the outermost layer is further improved and wear resistance of the outermost layer is further improved.

The silicone chain as the side chain and the main chain preferably has a dimethylsiloxane structure as a repeat unit, and the number of repeat units is preferably 3 or more and 100 or less, more preferably 3 or more and 50 or less, and still more preferably 3 or more and 30 or less.

A weight average molecular weight of the silicone surface treating agent is not particularly limited, but is preferably 1,000 or more and 50,000 or less. It should be noted that the weight average molecular weight of the silicone surface treating agent can be measured by gel permeation chromatography (GPC).

The silicone surface treating agent can be used alone or in a combination of two or more thereof. In addition, the silicone surface treating agent may be a synthetic product or may be a commercial product. As a specific example of a commercial product of a surface treating agent having a silicone chain as a side chain of a poly(meth)acrylate main chain, SYMAC (registered trademark) US-350 (which is manufactured by TOAGOSEI CO., LTD), KP-541, KP-574, and KP-578 (which are manufactured by Shin-Etsu Chemical Co., Ltd), and the like can be considered. Further, as a specific example of a commercial product of a surface treating agent having a silicone chain as a side chain of a silicone main chain, KF-9908 and KF-9909 (which are manufactured by Shin-Etsu Chemical Co., Ltd), and the like can be considered.

It is preferable that at least the second conductive metal oxide particles (D2) having the largest number average primary particle diameter among the conductive metal oxide particles D1 and D2 described above are surface-treated with the surface treating agent having a silicone chain as a side chain. As D2 is subjected to the silicone surface treatment, dispersibility of the conductive metal oxide particles in the outermost layer can be improved and wear resistance can be further improved. Further, as a particle having a large particle diameter, which easily comes into contact with the toner, is surface-treated, a potential of the surface of the photoreceptor is difficult to change, and it is easy to achieve the effect of suppressing the fogging.

Further, the second conductive metal oxide particles (D2) having the largest number average primary particle diameter among the conductive metal oxide particles D1 and D2 described above are preferably particles (composite particles) each having a core-shell structure including a core and a shell formed of the conductive metal oxide. In a case of a particle which does not have the core-shell structure, a difference in refractive index with respect to the polymerizable monomer becomes large, and transmittance of active energy rays (in particular, ultraviolet rays) used for curing of the outermost layer deteriorates, and as a result, a film strength of the outermost layer after the curing is insufficient in some cases. If the second conductive metal oxide particles have the core-shell structure, an amount of the surface treating agent on surfaces of the particles can be increased, and as a result, dispersibility of the second conductive metal oxide particles in the outermost layer is improved and transmittance of active energy rays (in particular, ultraviolet rays) can be improved. By dosing so, it is possible to increase the film strength of the outermost layer after the curing, and wear resistance is further improved.

A material for forming the core of the composite particle is not particularly limited, but barium sulfate, alumina, silicone oxide, and the like can be considered. Among these, barium sulfate (BaSO₄) is preferable in terms of securing light transmittance of the outermost layer. Further, a material for forming the shell of the composite particle is the same as those described as the examples of the conductive metal oxide forming the conductive metal oxide particles. As preferred examples of the composite particle having the core-shell structure, a composite particle including a core formed of barium sulfate and a shell formed of tin oxide can be considered. It should be noted that a ratio of a number average primary particle diameter of the core to a thickness of the shell may be appropriately set depending on types of the core and the shell to be used, and a combination thereof.

Surface Treatment Method Using Surface Treating Agent (Silicone Surface Treating Agent) Having Silicone Chain as Side Chain

A surface treatment method using the silicone surface treating agent is not particularly limited, as long as it is a method in which the silicone surface treating agent can adhere (or bond) to the surfaces of the conductive metal oxide particles. Such a method is generally largely divided into a wet treatment method and a dry treatment method, and any one thereof may be used.

It should be noted that in a case where conductive metal oxide particles after the reactive surface treatment to be described later are subjected to the silicone surface treatment, the silicone surface treating agent adheres (or bonds) to surfaces of the conductive metal oxide particles or the reactive surface treating agent.

The wet treatment method is a method in which the conductive metal oxide particles and the silicone surface treating agent are dispersed in a solvent to adhere (or bond) the silicone surface treating agent to the surfaces of the conductive metal oxide particles. As the method, a method in which the conductive metal oxide particles and the silicone surface treating agent are dispersed in the solvent and an obtained dispersion is dried to remove the solvent is preferable, and a method in which a heat treatment is additionally performed thereafter to make the silicone surface treating agent react with the conductive metal oxide particles, such that the silicone surface treating agent adheres (or bonds) to the surfaces of the conductive metal oxide particles is more preferable. Further, the surface treatment may be performed while simultaneously performing grain refinement of the conductive metal oxide particles by dispersing the silicone surface treating agent and the conductive metal oxide particles in the solvent and then performing wet pulverization of an obtained dispersion.

As a unit which disperses the conductive metal oxide particles and the silicone surface treating agent in the solvent, a known unit can be used without particular limitation, and as an example, a general dispersing unit such as a homogenizer, a ball mill, a sand mill, or the like can be considered.

As the solvent, a known solvent can be used without particular limitation, and as preferred examples of the solvent, an alcoholic solvent such as methanol, ethanol, n-propanol, isopropanol, n-butanol, sec-butanol (2-butanol), tert-butanol, benzyl alcohol, or the like, an aromatic hydrocarbon-based solvent such as toluene, xylene, or the like, and the like can be considered. These may be used alone or in a combination of two or more thereof. Among these, methanol, 2-butanol, toluene, and a mixed solvent of 2-butanol and toluene are more preferable.

A dispersion time is not particularly limited, but, for example, is preferably 1 minute or more and 600 minutes or less, more preferably 10 minutes or more and 360 minutes or less, and still more preferably 30 minutes or more and 120 minutes or less.

As a method for removing the solvent, a known method can be used without particular limitation, and as examples of the method for removing the solvent, a method in which an evaporator is used, a method is which the solvent is volatilized at room temperature, and the like can be considered.

A heating temperature is not particularly limited, but is preferably 50° C. or more and 250° C. or less, more preferably 70° C. or more and 200° C. or less, and still more preferably 90° C. or more and 150° C. or less. Further, a heating time is not particularly limited, but is preferably 1 minute or more and 600 minutes or less, more preferably 10 minutes or more and 300 minutes or less, and still more preferably 30 minutes or more and 90 minutes or less. It should be noted that the heating method is not particularly limited and a known method can be used.

The dry treatment method is a method in which the conductive metal oxide particles and the silicone surface treating agent are mixed and kneaded to adhere (or bond) the silicone surface treating agent to the surfaces of the conductive metal oxide particles. The method may be a method in which the conductive metal oxide particles and the silicone surface treating agent are mixed and kneaded and then a heat treatment is additionally performed to make the silicone surface treating agent react with the conductive metal oxide particles, such that the silicone surface treating agent adheres (or bonds) to the surfaces of the conductive metal oxide particles. Further, the surface treatment may be performed while simultaneously performing grain refinement of the conductive metal oxide particles by performing dry pulverization of the conductive metal oxide particles and the silicone surface treating agent when mixing and kneading the conductive metal oxide particles and the silicone surface treating agent.

A use amount of the silicone surface treating agent is preferably 0.1 parts by mass or more, more preferably 1 part by mass or more, and still more preferably 2 parts by mass or more, with respect to 100 parts by mass of conductive metal oxide particles (conductive metal oxide particles after the reactive surface treatment in a case of performing silicone surface treatment on the conductive metal oxide particles after the reactive surface treatment to be described later) before the treatment. When the use amount of the silicone surface treating agent is within this range, wear resistance of the outermost layer and the effect of suppressing the fogging are further improved.

Further, a use amount of the silicone surface treating agent is preferably 100 parts by mass or less, more preferably 10 part by mass or less, and still more preferably 5 parts by mass or less, with respect to 100 parts by mass of conductive metal oxide particles (conductive metal oxide particles after the reactive surface treatment in a case of performing the silicone surface treatment on the conductive metal oxide particles after the reactive surface treatment to be described later) before the silicone surface treatment. When the use amount of the silicone surface treating agent is within this range, a decrease in the film strength of the outermost layer caused by an unreacted silicone surface treating agent is suppressed and thus wear resistance of the outermost layer is improved.

A state in which the untreated conductive metal oxide particles or the conductive metal oxide particles after the reactive surface treatment are subjected to the silicone surface treatment can be confirmed by thermogravimetry/differential thermal analysis (TG/DTA) measurement, observation using a scanning electron microscope (SEM) or a transmission electron microscope (TEM), analysis using energy dispersive X-ray spectrometry (EDX), or the like.

It is preferable that the silicone surface-treated particles have a group derived from a polymerizable group. As the silicone surface-treated particles have a group derived from a polymerizable group, wear resistance of the outermost layer is improved. It is presumed that the reason is that the silicone surface-treated particles and the polymerizable monomer chemically bond to each other in the cured product forming the outermost layer to thereby improve the film strength of the outermost layer. A kind of the polymerizable group is not particularly limited, but is preferably a radical polymerizable group. A method for introducing the polymerizable group is not particularly limited, but is preferably a method in which the surface treatment is performed on the conductive metal oxide particles with the surface treating agent having the polymerizable group.

The fact that the silicone surface-treated particles have a polymerizable group, and that the silicone surface-treated particles in the outermost layer have a group derived from the polymerizable group can be confirmed by thermogravimetry/differential thermal analysis (TG/DTA) measurement, observation using a scanning electron microscope (SEM) or a transmission electron microscope (TEM), analysis using energy dispersive X-ray spectrometry (EDX), or a mass spectrometry, or the like.

Surface Treatment Method Using Surface Treating Agent (Reactive Surface Treating Agent) Having Polymerizable Group

It is preferable that the conductive metal oxide particles subjected to the silicone surface treatment are further surface-treated with the reactive surface treating agent. The polymerizable group is supported on the surfaces of the conductive metal oxide particles by the reactive surface treatment, and as a result, the silicone surface-treated particles further have the polymerizable group. Further, the silicone surface-treated particles are polymerized with the polymerizable monomer through the polymerizable group in the outermost layer and thus the outermost layer having a high film strength is formed, such that wear resistance of the outermost layer is further improved. At this time, the silicone surface-treated particles are present as a structure having the group derived from the polymerizable group in the outermost layer.

The reactive surface treating agent has a polymerizable group and a surface treatment functional group. A kind of the polymerizable group is not particularly limited, but is preferably a radical polymerizable group. Here, the radical polymerizable group represents a group having a carbon-carbon double bond, which is radical-polymerizable. As examples of the radical polymerizable group, a vinyl group, a (meth)acryloyl group, and the like can be considered, and among these, a methacryloyl group is preferable. In addition, the surface treatment functional group represents a group having reactivity to a polar group such as a hydroxyl group present on the surfaces of the conductive metal oxide particles, or the like. As examples of the surface treatment functional group, a carboxylic acid group, a hydroxyl group, —R′—COOH (R′ is a divalent hydrocarbon group), an alkylsilyl group, a halogenated silyl group, an alkoxysilyl group, and the like can considered, and among these, an alkylsilyl group, a halogenated silyl group, and an alkoxysilyl group are preferable.

The reactive surface treating agent is preferably a silane coupling agent having a radical polymerizable group, and as examples of the reactive surface treating agent, compounds represented by the following Formulas S-1 to S-32, and the like can be considered.

[Chem. 1]

CH₂═CHSi(CH₃)(OCH₃)₂ S-1:

CH₂═CHSi(OCH₃)₃ S-2:

CH₂═CHSiCl₃ S-3:

CH₂═CHCOO(CH₂)₂Si(CH₃)(OCH₃)₂ S-4:

CH₂═CHCOO(CH₂)₂Si(OCH₃)₃ S-5:

CH₂═CHCOO(CH₂)₂Si(OC₂H₅)(OCH₃)₂ S-6:

CH₂═CHCOO(CH₂)₃Si(OCH₃)₃ S-7:

CH₂═CHCOO(CH₂)₂Si(CH₃)Cl₂ S-8:

CH₂═CHCOO(CH₂)₂SiCl₃ S-9:

CH₂═CHCOO(CH₂)₃Si(CH₃)Cl₂ S-10:

CH₂═CHCOO(CH₂)₃SiCl₃ S-11:

CH₂═C(CH₃)COO(CH₂)₂Si(CH₃)(OCH₃)₂ S-12:

CH₂═C(CH₃)COO(CH₂)₃Si(OCH₃)₃ S-13:

CH₂═C(CH₃)COO(CH₂)₃Si(CH₃)(OCH₃)₂ S-14:

CH₂═C(CH₃)COO(CH₂)₃Si(OCH₃)₃ S-15:

CH₂═C(CH₃)COO(CH₂)₂Si(CH₃)Cl₂ S-16:

CH₂═C(CH₃)COO(CH₂)₂SiCl₃ S-17:

CH═C(CH₃)COO(CH₂)₃Si(CH₃)Cl₂ S-18:

CH₂═C(CH₃)COO(CH₂)₃SiCl₃ S-19:

CH₂═CHSi(CH₆)(OCH₃)₂ S-20:

CH₂═C(CH₃)Si(OCH₃)₃ S-21:

CH₂═C(CH₃)Si(OC₂H₅)₃ S-22:

CH₂═CHSi(OCH₃)₃ S-23:

CH₂═C(CH₃)Si(CH₃)(OCH₃)₂ S-24:

CH₂═CHSi(CH₃)Cl₂ S-25:

CH₂═CHCOOSi(OCH₃)₃ S-26:

CH₂═CHCOOSi(OC₂H₅)₃ S-27:

CH₂═C(CH₃)COOSi(OCH₃)₃ S-28:

CH₂═C(CH₃)COOSi(OC₂H₅)₃ S-29:

CH₂═C(CH₃)COO(CH₂)₃Si(OC₂H₅)₃ S-30:

CH₂═CHCOO(CH₂)₂Si(CH₃)₂(OCH₃) S-31:

CH₂═C(CH₃)COO(CH₂)₈Si(OCH₃)₃ S-32:

The reactive surface treating agent can be used alone or in a combination of two or more thereof. In addition, the reactive surface treating agent may be a synthetic product or may be a commercial product. As specific examples of the commercial product, KBM-502, KBM-503, KBE-502, KBE-503, and KBM-5103 (which are manufactured by Shin-Etsu Chemical Co., Ltd), and the like can be considered.

In a case of performing both of the silicone surface treatment and the reactive surface treatment, it is preferable that the silicone surface treatment is performed after performing the reactive surface treatment. As the surface treatments are performed in such an order, wear resistance of the outermost layer is further improved. The reason is that contact between the reactive surface treating agent and the surface of the conductive metal oxide particle is not obstructed by the silicone chain having an oil-repellent effect, and thus introduction of the polymerizable group to the conductive metal oxide particles is efficiently performed.

A reactive surface treatment method is not particularly limited, and a method which is the same as the method for the silicone surface treatment described above except for using the reactive surface treating agent can be adopted. In addition, a known technology for surface-treating metal oxide particles may be used.

In a case of performing the reactive surface treatment by using the wet treatment method, as the solvent, methanol, ethanol, and toluene are preferable, and methanol and toluene are more preferable.

A use amount of the reactive surface treating agent is preferably 0.5 parts by mass or more, more preferably 1 part by mass or more, and still more preferably 1.5 parts by mass or more, with respect to 100 parts by mass of the conductive metal oxide particles before the reactive surface treatment. When the use amount of the reactive surface treating agent is within this range, wear resistance of the outermost layer and the effect of suppressing the fogging are further improved. Further, a use amount of the reactive surface treating agent is preferably 15 parts by mass or less, more preferably 10 part by mass or less, and still more preferably 8 parts by mass or less, with respect to 100 parts by mass of the conductive metal oxide particles before the treatment. When the use amount of the reactive surface treating agent is within this range, the amount of reactive surface treating agent with respect to the number of hydroxyl groups on the surfaces of the particles does not become excessive but is in a more appropriate range and thus a decrease in the film strength of the outermost layer caused by the unreacted reactive surface treating agent is suppressed, such that wear resistance of the outermost layer is further improved.

### <Polymerizable Monomer>

The outermost layer-forming composition contains a polymerizable monomer. In the present specification, the polymerizable monomer represents a compound having a polymerizable group, and polymerized (cured) by irradiation with active energy rays such as ultraviolet rays, visible rays, electron rays, and the like, or by application of energy, such as heating or the like to become a binder resin of the outermost layer. It should be noted that the reactive surface treating agent is not included in the polymerizable monomer described in the present specification, and in a case where a polymerizable silicone compound or a polymerizable perfluoropolyether compound is used as the lubricant to be described later, the polymerizable silicone compound or the polymerizable perfluoropolyether compound is also not included in the polymerizable monomer.

A kind of the polymerizable group of the polymerizable monomer is not particularly limited, but is preferably a radical polymerizable group. Here, the radical polymerizable group represents a group having a carbon-carbon double bond, which is radical-polymerizable. As examples of the radical polymerizable group, a vinyl group, a (meth)acryloyl group, and the like can be considered, and a (meth)acryloyl group is preferable. When the polymerizable group is a (meth)acryloyl group, wear resistance of the outermost layer and the effect of suppressing the fogging are improved. It is presumed that the reason why the wear resistance of the outermost layer is improved is that efficient curing with a small light amount or within a short time is possible.

As examples of the polymerizable monomer, a styrene-based monomer, a (meth) acrylic monomer, a vinyl toluene-based monomer, a vinyl acetate-based monomer, an N-vinyl pyrrolidone-based monomer, and the like can be considered. These polymerizable monomers can be used alone or in a combination of two or more thereof.

The number of polymerizable groups per molecule in the polymerizable monomer is not particularly limited, but is preferably two or more, and more preferably three or more. When the number of polymerizable groups is within this range, wear resistance of the outermost layer is improved. It is presumed that the reason is that a crosslinking density of the outermost layer is increased, such that the film strength is further improved. Further, the number of polymerizable groups per molecule in the polymerizable monomer is not particularly limited, but is preferably six or less, more preferably five or less, and still more preferably four or less. When the number of polymerizable groups is within this range, uniformity of the outermost layer is improved and the effect of suppressing the fogging is improved. It is presumed that the reason is that the crosslinking density becomes a predetermined value or less, and curing shrinkage hardly occurs. In this regard, it is most preferable that the number of polymerizable groups per molecule in the polymerizable monomer is three.

As specific examples of the polymerizable monomer, although not particularly limited, the following compounds M1 to M11 can be considered, and among these, the following compound M2 is particularly preferable. In each of the following Formulas, R represents an acryloyl group (CH₂═CHCO—), and R′ represents a methacryloyl group (CH₂═C(CH₃)CO—).

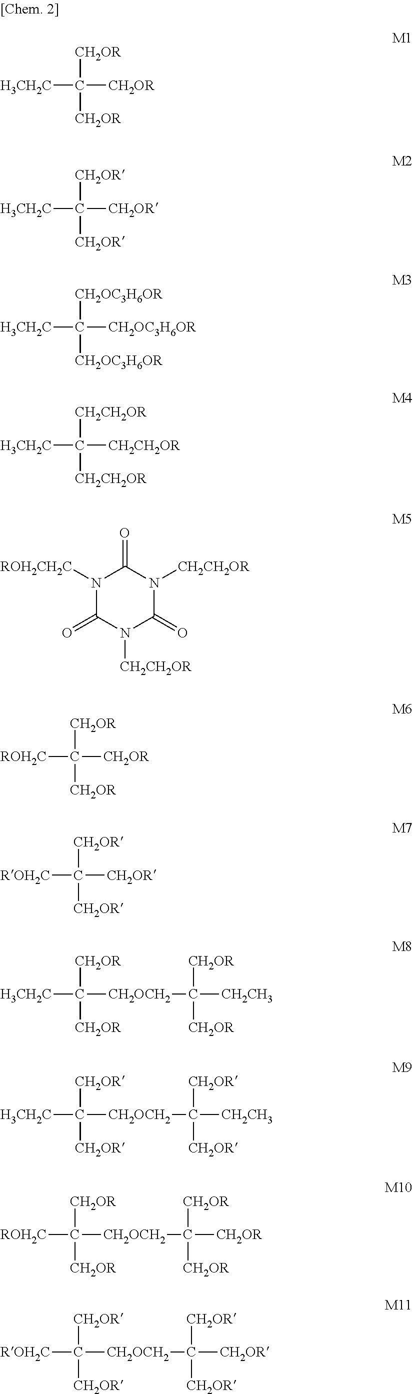

The polymerizable monomer may be used alone or in a combination of two or more thereof. In addition, the polymerizable monomer may be a synthetic product or may be a commercial product.

### <Polymerization Initiator>

It is preferable that the outermost layer-forming composition further contains a polymerization initiator. The polymerization initiator is used in a process of preparing a cured resin (binder resin) which can be obtained by performing a polymerization reaction of the polymerizable monomer. The polymerization initiator may be a thermopolymerization initiator or may be a photopolymerization initiator, but it is preferable that the polymerization initiator is a photopolymerization initiator. Further, in a case where the polymerizable monomer is a radical polymerizable monomer, it is preferable that the polymerization initiator is a radical polymerization initiator. As the radical polymerization initiator, a known radical polymerization initiator can be used without particular limitation, and as examples of the radical polymerization initiator, an alkylphenon-based compound, a phosphine oxide-based compound, and the like can be considered. Among these, a compound having an α-aminoalkylphenone structure or an acylphosphine oxide structure is preferable, and a compound having an acylphosphine oxide structure is more preferable. As an example of the compound having an acylphosphine oxide structure, IRGACURE (registered trademark) 819 (bis(2,4,6-trimethylbenzoyl)phenylphosphine oxide)(manufactured by BASF Japan Ltd.) can be considered.

These polymerization initiators may be used alone or in a combination of two or more thereof.

A use amount of the polymerization initiator is preferably 0.1 parts by mass or more and 40 parts by mass or less, and more preferably 0.5 parts by mass or more and 20 parts by mass or less, with respect to 100 parts by mass of the polymerizable monomer.

### <Charge Transport Material>

The outermost layer-forming composition may further contain a charge transport material. The charge transport material is not particularly limited and a known material can be used. As examples of the charge transport material, a carbazole derivative, an oxazole derivative, an oxadiazole derivative, a thiazole derivative, a thiadiazole derivative, a triazole derivative, an imidazole derivative, an imidazolone derivative, an imidazolidine derivative, a bisimidazolidine derivative, a styryl compound, a hydrazone compound, a pyrazoline compound, an oxazolone derivative, a benzimidazole derivative, a quinazoline derivative, a benzofuran derivative, an acridine derivative, a phenazine derivative, an aminostilbene derivative, a triarylamine derivative, a phenylenediamine derivative, a stilbene derivative, a benzidine derivative, and the like can be considered. Among these, a triarylamine derivative is preferable. As the triarylamine derivative, compounds represented by the following Chemical Formula 1 are preferable.

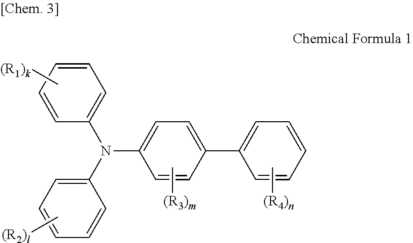

In Chemical Formula 1 above, R₁, R₂, R₃, and R₄ each independently represent an alkyl group having 1 to 7 carbon atoms or an alkoxy group having 1 to 7 carbon atoms. k, l, and n each independently represent an integer of 0 to 5, and m represents an integer of 0 to 4. Here, in a case where k, l, n, or m is 2 or more, a plurality of R₁ may be the same as or different from each other, a plurality of R₂ may be the same as or different from each other, a plurality of R₃ may be the same as or different from each other, and a plurality of R₄ may be the same as or different from each other. Among these, preferably, R₁, R₂, R₃, and R₄ each independently are an alkyl group having 1 to 3 carbon atoms. Further, it is preferable that k, l, n, and m each independently are 0 or 1.

As the compounds represented by Chemical Formula 1 above, for example, compounds described in JP 2015-114454 A can be used, and furthermore, the compounds represented by Chemical Formula 1 above can be synthesized by using a known synthesis method, for example, a method disclosed in JP 2006-143720 A, and the like.

### <Other Components>

The outermost layer-forming composition may further contain components other than the components described above. As examples of other components, although not particularly limited, a lubricant or the like can be considered in a case where the outermost layer is the protective layer. The lubricant is not particularly limited and a known lubricant can be used, and as examples of the lubricant, a polymerizable silicone compound, a polymerizable perfluoropolyether compound, and the like can be considered.

### (Method for Preparing Electrophotographic Photoreceptor)

The electrophotographic photoreceptor according to the embodiment of the present invention can be prepared by using a known method for preparing the electrophotographic photoreceptor without particular limitation, except for using an outermost layer-forming coating liquid including the outermost layer-forming composition according to the present invention. In particular, it is preferable that the electrophotographic photoreceptor is prepared by using a method including a process of applying the coating liquid including the outermost layer-forming composition on a surface of the photosensitive layer formed on the conductive support, and a process of obtaining a cured product of the outermost layer-forming composition by irradiating the applied outermost layer-forming coating liquid with active energy rays or heating the applied outermost layer-forming coating liquid.

The outermost layer-forming coating liquid contains the outermost layer-forming composition containing a polymerizable monomer and conductive metal oxide particles (and/or surface-treated particles). The outermost layer-forming composition may further contain other components such as a polymerization initiator and the like. In addition, it is preferable that the outermost layer-forming coating liquid contains the outermost layer-forming composition and a dispersion medium.

As the dispersion medium used in the outermost layer forming-coating liquid, any dispersion medium can be used as long as it can dissolve or disperse the polymerizable monomer, the conductive metal oxide particles (and/or the surface-treated particles), and the polymerization initiator and the like added as necessary. In detail, for example, methanol, ethanol, n-propanol, isopropanol, n-butanol, 2-butanol (sec-butanol), tert-butanol, benzyl alcohol, toluene, xylene, methyl ethyl ketone, cyclohexane, ethyl acetate, butyl acetate, methyl cellosolve, ethyl cellosolve, tetrahydrofuran, 1,3-dioxane, 1,3-dioxolane, pyridine, diethylamine, and the like can be considered. The dispersion medium can be used alone or in a combination of two or more thereof.

A content of the dispersion medium based on the total mass of the outermost layer-forming coating liquid is not particularly limited, but is preferably 1 mass % or more and 99 mass % or less, more preferably 40 mass % or more and 90 mass % or less, and still more preferably 50 mass % or more and 80 mass % or less.

A content of the polymerizable monomer in the outermost layer-forming composition is not particularly limited, but is preferably 30 mass % or more, more preferably 40 mass % or more, and still more preferably 50 mass % or more. When the content of the polymerizable monomer is within this range, the crosslinking density of the outermost layer is increased and the film strength is improved, such that wear resistance of the outermost layer is further improved. In addition, the content of the polymerizable monomer in the outermost layer-forming composition is not particularly limited, but is preferably 80 mass % or less, more preferably 70 mass % or less, and still more preferably 60 mass % or less.

A content of the conductive metal oxide particles (and/or the surface-treated particles) in the outermost layer-forming composition is not particularly limited, but is preferably 20 mass % or more, more preferably 30 mass % or more, and still more preferably 40 mass % or more. When the content of the conductive metal oxide particles (and/or the surface-treated particles) is within this range, the crosslinking density of the outermost layer is increased and the mechanical strength is further improved, such that wear resistance of the outermost layer is further improved. In addition, the content of the conductive metal oxide particles (and/or the surface-treated particles) in the outermost layer-forming composition is not particularly limited, but is preferably 70 mass % or less, more preferably 60 mass % or less, and still more preferably 50 mass % or less.

When the outermost layer-forming composition includes the polymerization initiator, the content of polymerizable initiator is not particularly limited, but is preferably 0.1 parts by mass or more, more preferably 1 part by mass or more, and still more preferably 5 parts by mass or more, with respect to 100 parts by mass of the polymerizable monomer. When the number of polymerizable groups is within this range, wear resistance of the outermost layer is improved. The reason is that the crosslinking density of the outermost layer is increased and the mechanical strength is further improved, such that wear resistance of the outermost layer is further improved. Further, the content of polymerizable initiator in the outermost layer-forming composition is not particularly limited, but is preferably 40 parts by mass or less, more preferably 30 parts by mass or less, and still more preferably 20 parts by mass or less, with respect to 100 parts by mass of the polymerizable monomer.

A method for preparing the outermost layer forming-coating liquid is not particularly limited, as long as the polymerizable monomer, the conductive metal oxide particles (and/or the surface-treated particles), and various additives such as the polymerization initiator and the like added as necessary are added to the dispersion medium and stirred to be mixed until the polymerizable monomer, the conductive metal oxide particles (and/or the surface-treated particles), and the various additives are dissolved or dispersed.

The outermost layer according to the present invention can be formed by applying the outermost layer-forming coating liquid prepared by using the method described above on the photosensitive layer and then drying and curing the applied outermost layer-forming coating liquid.

In the process of applying, drying, and curing, a reaction between the polymerizable monomers, a reaction between the polymerizable monomer and the conductive metal oxide particles subjected to the reactive surface treatment, a reaction between the conductive metal oxide particles subjected to the reactive surface treatment, and the like proceed, such that the outermost layer (protective layer) including the cured product of the outermost layer-forming composition is formed.

A method for applying the outermost layer-forming coating liquid is not particularly limited, and for example, a known method such as a dip coating method, a spray coating method, a spinner coating method, a bead coating method, a blade coating method, a beam coating method, a slide hopper coating method, a circular slide hopper coating method, or the like can be used.

After applying the coating liquid, natural drying or heat drying is performed to form a coating film, and then the coating film is cured by irradiating the coating film with the active energy rays. As the active energy rays, ultraviolet rays or electron rays are preferable, and ultraviolet rays are more preferable.

As an ultraviolet light source, any light source which generates ultraviolet rays can be used without limitation. For example, a low pressure mercury lamp, a medium pressure mercury lamp, a high pressure mercury lamp, a super high pressure mercury lamp, a carbon arc lamp, a metal halide lamp, a xenon lamp, a flash (pulsed) xenon lamp, and the like can be used. An irradiation condition varies for each lamp, however, an irradiation amount (light integral) of ultraviolet rays is preferably 5 mJ/cm² or more and 5,000 mJ/cm² or less, and more preferably 10 mJ/cm² or more and 2,000 mJ/cm² or less. Further, an irradiance of ultraviolet rays is preferably 5 mW/cm² or more and 500 mW/cm² or less, and more preferably 10 mW/cm² or more and 100 mW/cm² or less.

An irradiation time for obtaining a necessary irradiation amount (light integral) of the active energy rays is preferably 0.1 seconds or more and 10 minutes or less, and more preferably 0.1 seconds or more and 5 minutes or less in terms of operation efficiency.

In the process of forming the protective layer, drying can be performed before or after irradiation with the active energy rays, or during the irradiation with the active energy rays, and a timing to perform the drying can be appropriately selected by a combination thereof.

A drying condition can be appropriately selected depending on a kind of solvent, a film thickness, and the like. A drying temperature is preferably 20° C. or more and 180° C. or less, and more preferably 80° C. or more and 140° C. or less, and a drying time is preferably 1 minute or more and 200 minutes or less and more preferably 5 minutes or more and 100 minutes or less.

A film thickness of the outermost layer is preferably 1 μm or more and 10 μm or less, and more preferably 1.5 μm or more and 5 μm or less.

It should be noted that a state in which the outermost layer includes the cured product of the composition can be confirmed by a known analysis method such as pyrolysis-GC-MS, nuclear magnetic resonance (NMR), Fourier transform infrared spectrophotometer (FT-IR), elementary analysis, or the like.

### [Image Forming Apparatus]

The electrophotographic photoreceptor of the present invention is suitably used for an electrophotographic image forming apparatus. That is, the present invention also provides an image forming apparatus including the electrophotographic photoreceptor according to the present invention, a charging unit which charges a surface of the electrophotographic photoreceptor, an exposing unit which exposes the electrophotographic photoreceptor charged by the charging unit to form an electrostatic latent image, a developing unit which supplies a toner to the electrophotographic photoreceptor on which the electrostatic latent image is formed to form a toner image, a lubricant supply unit which supplies a lubricant to the surface of the electrophotographic photoreceptor, a transfer unit which transfers the toner image formed on the electrophotographic photoreceptor, and a cleaning unit which removes the toner remaining on the surface of the electrophotographic photoreceptor.

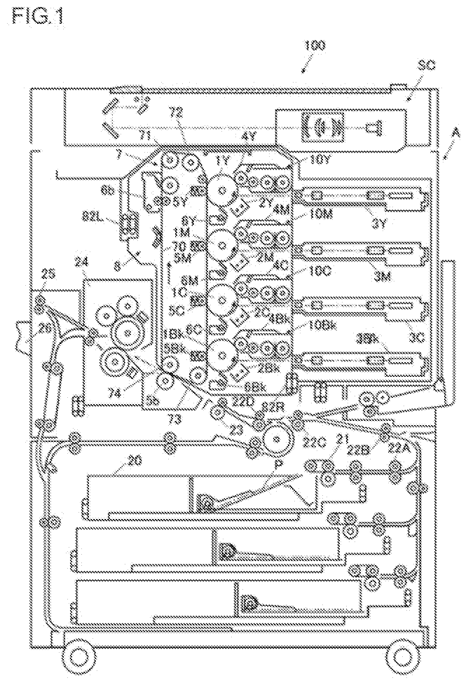

FIG. 1 is a schematic cross-sectional view illustrating an example of a configuration of the image forming apparatus according to the present invention. An image forming apparatus 100 illustrated in FIG. 1 can also be called a tandem type color image forming apparatus, and includes four image forming units 10Y, 10M, 10C, and 10Bk, an endless-belt-shaped intermediate transfer body unit 7, a paper feeding unit 21, a fixing unit 24, and the like. A document image reading device SC is disposed at an upper portion of an apparatus main body A of the image forming apparatus 100.

The image forming unit 10Y forming a yellow image includes a charging unit 2Y, an exposing unit 3Y, a developing unit 4Y, a primary transfer roller (primary transfer unit) 5Y, and a cleaning unit 6Y, which are sequentially arranged around a drum-shaped photoreceptor 1Y along a rotation direction of the photoreceptor 1Y.

The image forming unit 10M forming a magenta image includes a charging unit 2M, an exposing unit 3M, a developing unit 4M, a primary transfer roller (primary transfer unit) 5M, and a cleaning unit 6M, which are sequentially arranged around a drum-shaped photoreceptor 1M along a rotation direction of the photoreceptor 1M.

The image forming unit 10C forming a cyan image includes a charging unit 2C, an exposing unit 3C, a developing unit 4C, a primary transfer roller (primary transfer unit) 5C, and a cleaning unit 6C, which are sequentially arranged around a drum-shaped photoreceptor 1C along a rotation direction of the photoreceptor 1C.

The image forming unit 10Bk forming a black image includes a charging unit 2Bk, an exposing unit 3Bk, a developing unit 4Bk, a primary transfer roller (primary transfer unit) 5Bk, and a cleaning unit 6Bk, which are sequentially arranged around a drum-shaped photoreceptor 1Bk along a rotation direction of the photoreceptor 1Bk.

As the photoreceptors 1Y, 1M, 1C, and 1Bk, the electrophotographic photoreceptor according to the present invention is used.

The image forming units 10Y, 10M, 10C, and 10Bk are different from each other only in regard to a color of a toner image formed on each of the photoreceptors 1Y, 1M, 1C, and 1Bk, and are configured in the same manner. Therefore, the image forming unit 10Y will be described in detail by way of example, and a description of the image forming units 10M, 10C, and 10Bk will be omitted.

The image forming unit 10Y includes the charging unit 2Y, the exposing unit 3Y, the developing unit 4Y, the primary transfer roller (primary transfer unit) 5Y, and the cleaning unit 6Y arranged around the photoreceptor 1Y which is an image forming body, and forms a yellow (Y) toner image on the photoreceptor 1Y. Furthermore, according to the present embodiment, in the image forming unit 10Y, at least the photoreceptor 1Y, the charging unit 2Y, the developing unit 4Y, and the cleaning unit 6Y are provided in an integrated form.

The charging unit 2Y is a unit which applies a uniform potential to the photoreceptor 1Y, and for example, a corona discharge type charger is used.

The exposing unit 3Y is a unit which performs exposure on the photoreceptor 1Y to which a uniform potential is applied by the charging unit 2Y based on an image signal (yellow) to form an electrostatic latent image corresponding to a yellow image. As the exposing unit 3Y, for example, one constituted by an LED in which light emitting elements are arranged in an array in an axial direction of the photoreceptor 1Y, and an image forming element, or a laser optical system is used.

The developing unit 4Y is constituted by, for example, a developing sleeve in which a magnet is embedded to retain and rotate a developer, and a voltage applying device which applies a direct current (DC) bias voltage and/or an alternating current (AC) bias voltage between the photoreceptor 1Y and the developing sleeve.

The primary transfer roller 5Y is a unit (primary transfer unit) which transfers the toner image formed on the photoreceptor 1Y to an endless-belt-shaped intermediate transfer body 70. The primary transfer roller 5Y is disposed while abutting the intermediate transfer body 70.

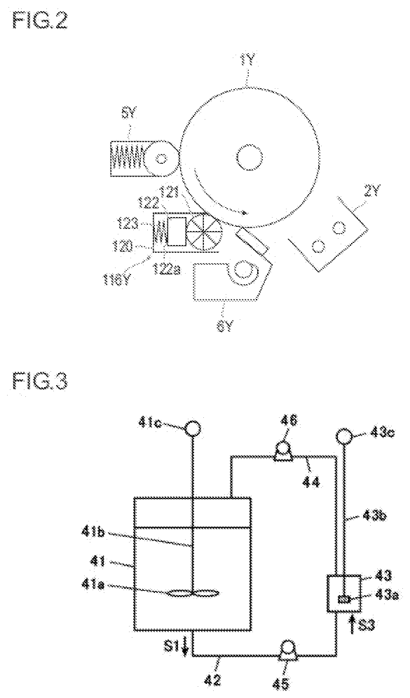

A lubricant supply unit 116Y which supplies (applies) a lubricant to a surface of the photoreceptor 1Y is, for example, as illustrated in FIG. 2, provided at a downstream side of the primary transfer roller (primary transfer unit) 5Y and at an upstream side of the cleaning unit 6Y. However, the cleaning unit 6Y may also be provided at a downstream side of the cleaning unit 6Y.

As a brush roller 121 constituting the lubricant supply unit 116Y, for example, one formed in a manner that a pile woven fabric in which a basic fabric is interwoven with a bundle of fibers as pile yarn is formed in a ribbon-shaped fabric, wound around a metal shaft in a spiral shape so that a raised surface faces outside, and bonded can be considered. The brush roller 121 of this example is formed by, for example, forming a long woven fabric in which brush fibers formed of a resin such as polypropylene or the like are implanted with high density, on a circumferential surface of a base body of a roller.

It is preferable that a brush hair is a straight hair type raising in a direction perpendicular to the metal shaft in terms of applicability of the lubricant. Yarn used for the brush hair is preferably filament yarn, and as a material of the yarn, a synthetic resin such as polyamide such as 6-nylon, 12-nylon, or the like, polyester, an acrylic resin, vinylon, or the like can be considered, and the yarn may be formed by kneading carbon or a metal such as nickel or the like in order to improve conductivity. It is preferable that a thickness of the brush fiber is, for example, 3 denier or more and 7 denier or less, a length of the brush fiber is, for example, 2 mm or more and 5 mm or less, an electrical resistivity of the brush fiber is, for example, 1×10¹⁰Ω or less, a Young's modulus of the brush fiber is 4,900 N/mm² or more and 9,800 N/mm² or less, an implantation density (the number of brush fibers per unit area) of the brush fibers is, for example, 50,000 fibers/square inch or more and 200,000 fibers/square inch or less (50 k fibers/inch² or more and 200 k fibers/inch² or less). It is preferable that an intrusion amount of the brush roller 121 into the photoreceptor is 0.5 mm or more and 1.5 mm or less. A rotational speed of the brush roller is, for example, a peripheral speed ratio of 0.3 or more and 1.5 or less with respect to the photoreceptor, and the brush roller may rotate in the same direction as the rotation direction of the photoreceptor, or may rotate in a reverse direction.

As a pressurizing spring 123, one which pressurizes a lubricant 122 in a direction toward the photoreceptor 1Y so that a pressurizing force of the brush roller 121 with respect to the photoreceptor 1Y is, for example, 0.5 N or more and 1.0 N or less.

In the lubricant supply unit 116Y, for example, a pressurizing force of the lubricant 122 with respect to the brush roller 121 and the rotational speed of the brush roller 121 are adjusted so that an application amount per cm² of the surface of the photoreceptor 1Y is 0.5×10⁻⁷ g/cm² or more and 1.5×10⁻⁷ g/cm² or less.

A kind of lubricant 122 is not particularly limited, and a known lubricant can be appropriately selected, but it is preferable that the lubricant 122 contains a fatty acid metal salt.

As the fatty acid metal salt, a saturated or unsaturated fatty acid metal salt having 10 or more carbon atoms is preferable, for example, zinc laurate, barium stearate, lead stearate, iron stearate, nickel stearate, cobalt stearate, copper stearate, strontium stearate, calcium stearate, cadmium stearate, magnesium stearate, zinc stearate, aluminum stearate, indium stearate, potassium stearate, lithium stearate, sodium stearate, zinc oleate, magnesium oleate, iron oleate, cobalt oleate, copper oleate, lead oleate, manganese oleate, aluminum oleate, zinc palmitate, cobalt palmitate, lead palmitate, magnesium palmitate, aluminum palmitate, calcium palmitate, lead caprate, zinc linoleate, cobalt linoleate, calcium linoleate, zinc ricinoleate, cadmium ricinoleate, and the like can be considered.

The cleaning unit 6Y is constituted by a cleaning blade and a brush roller provided at an upstream side of the cleaning blade.

The endless-belt-shaped intermediate transfer body unit 7 is wound on a plurality of rollers 71 to 74 and includes the endless-belt-shaped intermediate transfer body 70 which is rotatably supported. In the endless-belt-shaped intermediate transfer body unit 7, a cleaning unit 6b which removes the toner is disposed on the intermediate transfer body 70.

Further, a housing 8 is constituted by the image forming units 10Y, 10M, 10C, and 10Bk, and the endless-bent-shaped intermediate transfer body unit 7. The housing 8 is configured to be drawable from the apparatus main body A through supporting rails 82L and 82R.

As the fixing unit 24, for example, one which is constituted by a heating roller including a heating source therein, and a pressurizing roller provided in a state of being pressure-welded to the heating roller so that a fixing nip portion is formed, and uses a heating roller fixing method can be considered.

It should be noted that the image forming apparatus 100 is a color laser printer in the embodiment described above, but the image forming apparatus 100 may also be a monochrome laser printer, a copy machine, a multifunction printer, or the like. Further, an exposure light source may be a light source other than a laser, for example, an LED light source or the like.

### [Image Forming Method]

An image forming method of the present invention includes a charging process of charging a surface of the electrophotographic photoreceptor of the present invention, an exposing process of exposing the charged electrophotographic photoreceptor to form an electrostatic latent image, a developing process of supplying a toner to the electrophotographic photoreceptor on which the electrostatic latent image is formed to form a toner image, a transfer process of transferring the toner image formed on the electrophotographic photoreceptor, a lubricant supply process of supplying a lubricant to the surface of the electrophotographic photoreceptor, and a cleaning process of removing the toner remaining on the surface of the electrophotographic photoreceptor.

In the image forming apparatus 100 configured as described above, an image is formed on a paper P as described below.

First, the surfaces of the photoreceptors 1Y, 1M, 1C, and 1Bk are negatively charged by the charging units 2Y, 2M, 2C, and 2Bk, respectively (charging process).

Next, the surfaces of the photoreceptors 1Y, 1M, 1C, and 1Bk are exposed by the exposing units 3Y, 3M, 3C, and 3Bk based on an image signal to form electrostatic latent images (exposing process).

Next, the toner is applied to the surfaces of the photoreceptors 1Y, 1M, 1C, and 1Bk by the developing units 4Y, 4M, 4C, and 4Bk to perform development, thereby forming toner images (developing process).

Next, toner images of respective colors formed on the photoreceptors 1Y, 1M, 1C, and 1Bk are sequentially transferred (primary transfer, transfer process) to the rotating intermediate transfer body 70 by the primary transfer rollers 5Y, 5M, 5C, and 5Bk, respectively, to form a color image on the intermediate transfer body 70.

Then, after separating the primary transfer rollers 5Y, 5M, 5C, and 5Bk and the intermediate transfer body 70 from each other, the lubricant is supplied to the surfaces of the photoreceptors 1Y, 1M, 1C, and 1Bk by the lubricant supply unit (lubricant supply process).

Thereafter, the toner remaining on the surfaces of the photoreceptors 1Y, 1M, 1C, and 1Bk is removed by the cleaning units 6Y, 6M, 6C, and 6Bk.

Then, in preparation for the next image forming process, the photoreceptors 1Y, 1M, 1C, and 1Bk are negatively charged by the charging units 2Y, 2M, 2C, and 2Bk, respectively.

Meanwhile, the paper P is fed by the paper feeding unit 21 from a paper feeding cassette 20, and conveyed to a secondary transfer portion (secondary transfer unit) 5b via a plurality of intermediate rollers 22A, 22B, 22C, and 22D, and a resist roller 23. Then, the color image is transferred (secondary transfer) to the paper P by the secondary transfer portion 5b.

After the paper P to which the color image is transferred as described above is subjected to a fixing processing by the fixing unit 24, the paper P is pinched by a paper discharge roller 25 to be discharged to the outside of the apparatus, and then is placed on a paper discharge tray 26. Further, after the paper P is separated from the intermediate transfer body 70, the toner remaining on the intermediate transfer body 70 is removed by the cleaning unit 6b.

As described above, an image can be formed on the paper P.

### [Toner]

The toner used in the image forming method and the image forming apparatus of the present invention is not particularly limited, but it is preferable that the toner contains toner particles including a binding resin and a coloring agent, and the toner particles may contain other components such as a releasing agent or the like as necessary.

It is preferable that a volume-averaged particle diameter of the toner particles is 2 μm or more and 8 μm or less in terms of realization of a high image quality.

A method for preparing the toner is not particularly limited, but for example, a general pulverization method, a wet melting and conglobating method in which the toner is prepared in a dispersion medium, a known polymerization method such as suspension polymerization, dispersion polymerization, an emulsion polymerization aggregation method, or the like, and the like can be considered.

Further, as an external additive, inorganic particles such as silica and titania having an average particle diameter of about 10 nm or more and 300 nm or less, an abrasive having an average particle diameter of about 0.2 μm or more and 3 μm or less, or the like can be appropriately added to the toner particles.

The toner can be used as a magnetic or nonmagnetic one-component developer, but may also be used as a two-component developer by being mixed with a carrier.

In a case of using the toner as the two-component developer, as the carrier, magnetic particles formed of a material known in the art, such as a ferromagnetic metal such as iron or the like, an alloy of a ferromagnetic metal, and aluminum, lead, and the like, a compound of a ferromagnetic metal such as ferrite, magnetite, and the like, or the like can be used, and ferrite is particularly preferable.

Hereinabove, the embodiment of the present invention has been described, but the present invention is not limited to the embodiment described above, and various modifications can be made.

Further, in the image forming apparatus of the present invention, a lubricant removing unit which removes the lubricant from the surface of the photoreceptor may also be provided. In detail, the image forming apparatus is configured in a form in which the lubricant supply unit 116Y is provided, for example, at a downstream side of the cleaning unit 6Y and at an upstream side of the charging unit 2Y, and further, the lubricant removing unit is disposed at a downstream side of the lubricant supply unit 116Y and at an upstream side of the charging unit 2Y, in the rotational direction of the photoreceptor 1Y.

It is preferable that the lubricant removing unit is a unit in which a removing member comes into contact with the surface of the photoreceptor 1Y to remove the lubricant by a mechanical action, and the removing member such as a brush roller, a foaming roller, or the like can be used.

That is, the image forming method of the present invention may further include a lubricant removing process.

### EXAMPLES

The effects of the present invention will be described by using the following Examples and Comparative Examples. However, the technical scope of the present invention is not limited only to the following Examples. It should be noted that in the following Examples, unless otherwise specified, an operation was performed at room temperature (25° C.). In addition, unless otherwise specified, “%” and “part” mean “mass %” and “part by mass”, respectively.

A number average primary particle diameter of various particles was measured as described below. First, a photograph taken by a scanning electron microscope (manufactured by JEOL Ltd.) at 10,000 magnification is put into a scanner. Next, 300 particle images except for agglomerated particle images in the obtained photograph image were randomly binarized by using LUZEX (registered trademark) AP software ver. 1.32 (manufactured by NIRECO Corporation) which is an automatic image processing analyzing system to calculate horizontal Feret diameters of the respective particle images. Then, an average value of the horizontal Feret diameters of the respective particle images was calculated as the number average primary particle diameter. Here, measurement of the number average primary particle diameter of conductive metal oxide particles was performed on conductive metal oxide particles which do not include a surface-treating-agent-derived chemical species (coating layer).

### Synthesis Example 1: Preparation of Composite Particles (Core-Shell Particles)

### (Composite Particles 1)

A composite particle in which a coating layer (shell) formed of tin oxide (SnO₂) is formed on a surface of a barium sulfate (BaSO₄) core was prepared by using a preparation apparatus illustrated in FIG. 3.

In detail, 3,500 cm³ of pure water was put into a mother-liquor tank 11, and then 900 g of spherical barium sulfate cores of which a number average primary particle diameter is 80 nm were put thereinto and circulated five times. A flow velocity of a slurry flowing out from the mother-liquor tank 11 was 2,280 cm³/min. Further, a stirring speed of a strong dispersion device 13 was 16,000 rpm. The slurry after the circulation is completed was diluted with pure water in a measuring flask to a total volume of 9,000 cm³, and 1,600 g of sodium stannate and 2.3 cm³ of an aqueous solution of sodium hydroxide (concentration of 25 N) were put thereinto and circulated five times. A mother liquor was obtained as described above.

A 20% sulfuric acid was supplied to a homogenizer “magic LAB (registered trademark)” (manufactured by IKA Japan K.K.) as a strong dispersion device 43 while circulating the mother liquor so that a flow velocity S1 at which the mother liquor flows out from a mother-liquor tank 41 is 200 cm³. A supply speed S3 was 9.2 cm³/min. A volume of the homogenizer was 20 cm³, and a stirring speed was 16,000 rpm. The circulation was performed for 15 minutes, and during the circulation, a sulfuric acid was continuously supplied to the homogenizer, and a slurry including particles was obtained.

The obtained slurry was repulp-washed until a conductivity of the slurry became 600 μS/cm or less, and then Nutsche filtration was performed to obtain a cake. The cake was dried in an atmosphere at 150° C. for 10 hours. Next, the dried cake was pulverized and the pulverized powder was subjected to reduction firing in a 1 vol. % H₂/N₂ atmosphere at 450° C. for 45 minutes. In this way, composite particles 1 having a number average primary particle diameter of 100 nm, each in which a shell formed of tin oxide is formed on a surface of a barium sulfate core, were prepared.

Here, in the preparation apparatus illustrated in FIG. 3, reference numerals 42 and 44 each represent a circulating pipe forming a circulation path between the mother-liquor tank 41 and the strong dispersion device 43, reference numerals 45 and 46 each represent a pump provided on each of the circulating pipes 42 and 44, a reference numeral 41a represents a stirring blade, a reference numeral 43a represents a stirring unit, reference numerals 41b and 43b each represent a shaft, and reference numerals 41c and 43c each represent a motor.

### (Composite Particles 2)

Composite particles 2 (number average primary particle diameter: 50 nm) were obtained in the same manner as that of the composite particles 1, except that barium sulfate cores having a number average primary particle diameter of 30 nm were used instead of the barium sulfate cores having a number average primary particle diameter of 80 nm.

### (Composite Particles 3)

Composite particles 3 (number average primary particle diameter: 45 nm) were obtained in the same manner as that of the composite particles 1, except that barium sulfate cores having a number average primary particle diameter of 25 nm were used instead of the barium sulfate cores having a number average primary particle diameter of 80 nm.

### (Composite Particles 4)

Composite particles 4 (number average primary particle diameter: 35 nm) were obtained in the same manner as that of the composite particles 1, except that barium sulfate cores having a number average primary particle diameter of 15 nm were used instead of the barium sulfate cores having a number average primary particle diameter of 80 nm.

### (Composite Particles 5)

Composite particles 5 (number average primary particle diameter: 500 nm) were obtained in the same manner as that of the composite particles 1, except that barium sulfate cores having a number average primary particle diameter of 480 nm were used instead of the barium sulfate cores having a number average primary particle diameter of 80 nm.

### (Composite Particles 6)

Composite particles 6 (number average primary particle diameter: 600 nm) were obtained in the same manner as that of the composite particles 1, except that barium sulfate cores having a number average primary particle diameter of 580 nm were used instead of the barium sulfate cores having a number average primary particle diameter of 80 nm.

### Synthesis Example 2: Preparation of Conductive Metal Oxide Particles (Surface-Treated Particles) Surface-Treated with Surface Treating Agent

### Synthesis Example 2-1: Preparation of Surface-Treated Particles 1

5 g of tin oxide (number average primary particle diameter: 100 nm) as untreated conductive metal oxide particles was added to 10 mL of methanol and dispersed at room temperature for 30 minutes by using a US homogenizer. Next, 0.25 g of 3-methacryloxypropyltrimethoxysilane (“KBM-503” manufactured by Shin-Etsu Chemical Co., Ltd) as the reactive surface treating agent and 10 mL of toluene were added and stirred at room temperature for 60 minutes. After removing a solvent by using an evaporator, heating was performed at 120° C. for 60 minutes to obtain conductive metal oxide particles surface-treated with the reactive surface treating agent.

5 g of the conductive metal oxide particles obtained as described above were added to 40 g of 2-butanol, and dispersed at room temperature for 60 minutes by using a US homogenizer. Next, 0.15 g of a surface treating agent (“KF-9908”, manufactured by Shin-Etsu Chemical Co., Ltd) having a silicone chain as a side chain of a silicone main chain is added, and further, dispersion was performed at room temperature for 60 minutes by using a US homogenizer. After the dispersion, a solvent was volatilized at room temperature, and drying was performed at 120° C. for 60 minutes to prepare conductive metal oxide particles (hereinafter, also referred to as surface-treated particles) 1 surface-treated with the reactive surface treating agent and the surface treating agent having a silicone chain as a side chain.

### Synthesis Example 2-2: Preparation of Surface-Treated Particles 2

5 g of tin oxide (number average primary particle diameter: 100 nm) was added to 10 mL of 2-butanol and dispersed at room temperature for 60 minutes by using a US homogenizer. Next, 0.15 g of 3-methacryloxypropyltrimethoxysilane (“KBM-503” manufactured by Shin-Etsu Chemical Co., Ltd) as the reactive surface treating agent was added and further, dispersion was performed at room temperature for 60 minutes by using a US homogenizer. After the dispersion, a solvent was volatilized at room temperature, and drying was performed at 120° C. for 60 minutes to prepare surface-treated particles 2 surface-treated with the reactive surface treating agent.

### Synthesis Example 2-3: Preparation of Surface-Treated Particles 3

Surface-treated particles 3 were prepared in the same manner as that of Synthesis Example 2-1, except that tin oxide having a number average primary particle diameter of 20 nm was used instead of tin oxide having a number average primary particle diameter of 100 nm.

### Synthesis Example 2-4: Preparation of Surface-Treated Particles 4

Surface-treated particles 4 were prepared in the same manner as that of Synthesis Example 2-2, except that tin oxide having a number average primary particle diameter of 20 nm was used instead of tin oxide having a number average primary particle diameter of 100 nm.

### Synthesis Example 2-5: Preparation of Surface-Treated Particles 5

Surface-treated particles 5 were prepared in the same manner as that of Synthesis Example 2-1, except that tin oxide having a number average primary particle diameter of 30 nm was used instead of tin oxide having a number average primary particle diameter of 100 nm.

### Synthesis Example 2-6: Preparation of Surface-Treated Particles 6

Surface-treated particles 6 were prepared in the same manner as that of Synthesis Example 2-1, except that tin oxide having a number average primary particle diameter of 10 nm was used instead of tin oxide having a number average primary particle diameter of 100 nm.

### Synthesis Example 2-7: Preparation of Surface-Treated Particles 7

Surface-treated particles 7 were prepared in the same manner as that of Synthesis Example 2-1, except that the composite particles 1 obtained as described above were used instead of tin oxide having a number average primary particle diameter of 100 nm.

### Synthesis Example 2-8: Preparation of Surface-Treated Particles 8

Surface-treated particles 8 were prepared in the same manner as that of Synthesis Example 2-2, except that the composite particles 1 obtained as described above were used instead of tin oxide having a number average primary particle diameter of 100 nm.

### Synthesis Example 2-9: Preparation of Surface-Treated Particles 9

Surface-treated particles 9 were prepared in the same manner as that of Synthesis Example 2-7, except that the surface treatment using KBM-503 was not performed.

### Synthesis Example 2-10: Preparation of Surface-Treated Particles 10

Surface-treated particles 10 were prepared in the same manner as that of Synthesis Example 2-1, except that the composite particles 2 obtained as described above were used instead of tin oxide having a number average primary particle diameter of 100 nm.

### Synthesis Example 2-11: Preparation of Surface-Treated Particles 11

Surface-treated particles 11 were prepared in the same manner as that of Synthesis Example 2-1, except that the composite particles 3 obtained as described above were used instead of tin oxide having a number average primary particle diameter of 100 nm.

### Synthesis Example 2-12: Preparation of Surface-Treated Particles 12

Surface-treated particles 12 were prepared in the same manner as that of Synthesis Example 2-1, except that the composite particles 4 obtained as described above were used instead of tin oxide having a number average primary particle diameter of 100 nm.

### Synthesis Example 2-13: Preparation of Surface-Treated Particles 13

Surface-treated particles 13 were prepared in the same manner as that of Synthesis Example 2-1, except that the composite particles 5 obtained as described above were used instead of tin oxide having a number average primary particle diameter of 100 nm.

### Synthesis Example 2-14: Preparation of Surface-Treated Particles 14

Surface-treated particles 14 were prepared in the same manner as that of Synthesis Example 2-1, except that the composite particles 6 obtained as described above were used instead of tin oxide having a number average primary particle diameter of 100 nm.

### Synthesis Example 2-15: Preparation of Surface-Treated Particles 15

Surface-treated particles 15 were prepared in the same manner as that of Synthesis Example 2-7, except that a surface treating agent (“KP-578”, manufactured by Shin-Etsu Chemical Co., Ltd) having a silicone chain as a side chain of a poly(meth)acrylate main chain was used instead of KF-9908.

### Synthesis Example 2-16: Preparation of Surface-Treated Particles 16

Surface-treated particles 16 were prepared in the same manner as that of Synthesis Example 2-7, except that a surface treating agent (“Novec2702”, manufactured by 3M Japan Limited) which is a fluorine-based surface treating agent and does not have a silicone chain as a side chain was used instead of KF-9908.

### Synthesis Example 2-17: Preparation of Surface-Treated Particles 17

Surface-treated particles 17 were prepared in the same manner as that of Synthesis Example 2-7, except that a surface treating agent (“KF-9901”, manufactured by Shin-Etsu Chemical Co., Ltd) which has a silicone main chain and does not have a silicone chain as a side chain was used instead of KF-9908.

### Synthesis Example 2-18: Preparation of Surface-Treated Particles 18

Surface-treated particles 18 were prepared in the same manner as that of Synthesis Example 2-1, except that titanium oxide (TiO₂) having a number average primary particle diameter of 100 nm was used instead of tin oxide having a number average primary particle diameter of 100 nm.

### Synthesis Example 2-19: Preparation of Surface-Treated Particles 19

Surface-treated particles 19 were prepared in the same manner as that of Synthesis Example 2-2, except that titanium oxide (TiO₂) having a number average primary particle diameter of 20 nm was used instead of tin oxide having a number average primary particle diameter of 100 nm.

Compositions of the surface-treated particles 1 to 19 are shown in the following Table 1.

TABLE 1

| | Untreated Conductive Metal Oxide Particle | | | | |
|---|---|---|---|---|---|
| | | Number Average | | Silicone Surface | Reactive Surface |
| Surface-Treated | | Primary Particle | | Treating Agent | Treating Agent |
| Particle No. | Kind | Diameter | | Kind | Kind |
| 1 | SnO₂ | 100 | nm | KF-9908 | KBM-503 |
| 2 | SnO₂ | 100 | nm | — | KBM-503 |
| 3 | SnO₂ | 20 | nm | KF-9908 | KBM-503 |
| 4 | SnO₂ | 20 | nm | — | KBM-503 |
| 5 | SnO₂ | 30 | nm | KF-9908 | KBM-503 |
| 6 | SnO₂ | 10 | nm | KF-9908 | KBM-503 |
| 7 | BaSO₄/SnO₂ | 100 | nm | KF-9908 | KBM-503 |
| 8 | BaSO₄/SnO₂ | 100 | nm | — | KBM-503 |
| 9 | BaSO₄/SnO₂ | 100 | nm | KF-9908 | — |
| 10 | BaSO₄/SnO₂ | 50 | nm | KF-9908 | KBM-503 |
| 11 | BaSO₄/SnO₂ | 45 | nm | KF-9908 | KBM-503 |
| 12 | BaSO₄/SnO₂ | 35 | nm | KF-9908 | KBM-503 |
| 13 | BaSO₄/SnO₂ | 500 | nm | KF-9908 | KBM-503 |
| 14 | BaSO₄/SnO₂ | 600 | nm | KF-9908 | KBM-503 |
| 15 | BaSO₄/SnO₂ | 100 | nm | KP-578 | KBM-503 |
| 16 | BaSO₄/SnO₂ | 100 | nm | Novec2702 | KBM-503 |
| | | | | Fluorine-Based | |
| | | | | Treating Agent | |
| 17 | BaSO₄/SnO₂ | 100 | nm | KF-9901 | KBM-503 |
| | | | | Straight-Chain Type | |
| 18 | TiO₂ | 100 | nm | KF-9908 | KBM-503 |
| 19 | TiO₂ | 20 | nm | — | KBM-503 |

### Preparation of Electrophotographic Photoreceptor

### Example 1

A. Preparation of Conductive Support

A surface of a cylindrical aluminum support was cut to prepare a conductive support.

B. Preparation of Intermediate Layer

The following components were mixed in the following amounts, and dispersion was performed for 10 hours using a sand mill as a disperser by a batch method to prepare a coating liquid for forming an intermediate layer. The coating liquid was applied to a surface of the conductive support by a dip coating method and dried at 110° C. for 20 minutes to form an intermediate layer having a film thickness of 2 μm on the conductive support. It should be noted that X1010 (manufactured by Daicel-Evonik Ltd.) was used as a polyamide resin, and SMT-500SAS (manufactured by TAYCA CORPORATION, number average primary particle diameter: 0.035 μm) was used as titanium oxide particles:

polyamide resin 10 parts by mass

titanium oxide particles 11 parts by mass

ethanol 200 parts by mass.

C. Preparation of Charge Generating Layer

The following components were mixed in the following amounts, and dispersion was performed at 19.5 kHz, 600 W, and a circulation flow rate of 40 L/hour for 0.5 hours by using a circulation type ultrasonic homogenizer (RUS-600TCVP, manufactured by NISSEI Corporation) to prepare a coating liquid for forming a charge generating layer. The obtained coating liquid was applied to a surface of the intermediate layer by a dip coating method, and air-dried to form a charge generating layer having a film thickness of 0.3 μm on the intermediate layer. It should be noted that as a charge generating material, a mixed crystal of 1:1 adduct of titanyl phthalocyanine having well-defined peaks at positions of 8.3°, 24.7°, 25.1°, and 26.5° in a Cu-Kα characteristic X-ray diffraction spectrum measurement, and (2R,3R)-2,3-butanediol, and non-added titanyl phthalocyanine, was used. Further, as a polyvinylbutyral resin, S-LEC (registered trademark) BL-1 (manufactured by SEKISUI CHEMICAL CO., LTD.) was used. In addition, as a mixed solvent, 3-methyl-2-butanone/cyclohexanone=4/1 (volume ratio) was used:

| | | |
|---|---|---|
| charge generating material | 24 | parts by mass |
| polyvinylbutyral resin | 12 | parts by mass |
| mixed solvent | 400 | parts by mass. |

D. Preparation of Charge Transport Layer

A coating liquid for a charge transport layer formed by mixing the following components in the following amounts was applied to a surface of the charge generating layer by a dip coating method, and dried at 120° C. for 70 minutes to form a charge transport layer having a film thickness of 24 μm on the charge generating layer. It should be noted that as a polycarbonate resin, Iupilon (registered trademark) Z300 (manufactured by MITSUBISHI GAS CHEMICAL COMPANY, INC., bisphenol Z-type polycarbonate) was used. Further, as an antioxidant, IRGANOX (registered trademark) 1010 (manufactured by BASF Japan Ltd.) was used:

| | | |
|---|---|---|
| charge transport material represented by the | 60 | parts by mass |
| following Chemical Formula 2 | | |
| polycarbonate resin | 100 | parts by mass. |
| antioxidant | 4 | parts by mass. |

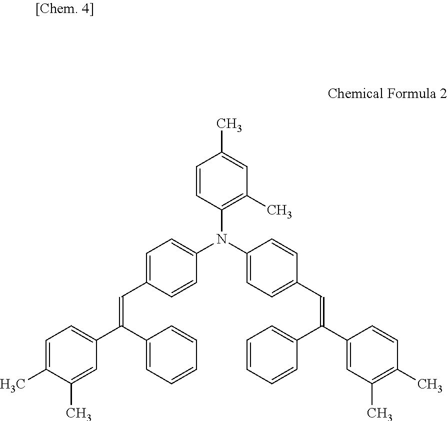

E. Preparation of Protective Layer (Outermost Layer)

A coating liquid (outermost layer-forming coating liquid) for forming a protective layer, formed by mixing the following components in the following amounts was applied to a surface of the charge transport layer by using a circular slide hopper coating machine. A film of the thus obtained coating liquid was cured by being irradiated with ultraviolet rays (dominant wavelength: 365 nm) for 1 minute by using a metal halide lamp (ultraviolet ray irradiance: 16 mW/cm² and light integral: 960 mJ/cm²) to form a protective layer having a film thickness of 3.0 μm on the charge transport layer. By doing so, a photoreceptor 1 was prepared. It should be noted that as a polymerization initiator, IRGACURE (registered trademark) 819 (manufactured by BASF Japan Ltd.) was used:

| | | |
|---|---|---|
| polymerizable monomer (a compound represented | 120 | parts by mass |
| by Chemical Formula M2 above) | | |
| surface-treated particles 1 | 50 | parts by mass |
| surface-treated particles 4 | 50 | parts by mass |
| polymerization initiator | 10 | parts by mass |
| 2-butanol | 400 | parts by mass. |

### Examples 2 to 17 and Comparative Examples 1 to 7

Photoreceptors 2 to 17, and comparative photoreceptors 1 to 7 were prepared in the same manner as that of Example 1, except that the kind of surface-treated particles was changed as shown in the following Table 2.

It should be noted that in a case where the photoreceptor includes two kinds of surface-treated particles, a ratio (part by mass) of the two kinds of surface-treated particles is 50 parts by mass/50 parts by mass, and in a case where the photoreceptor includes only one kind of surface-treated particles, a use amount of the surface-treated particles is 100 parts by mass. Further, particle diameter distributions of the conductive metal oxide particles in the outermost layers of the photoreceptors 1 to 17 obtained in Examples 1 to 17, and the comparative photoreceptors 3, 6, and 7 obtained in Comparative Examples 3, 6, and 7, respectively, were measured and it was confirmed that all the particle diameter distributions show a bimodal distribution.

### [Evaluation]

### <Wear Resistance>

Each photoreceptor obtained as described above was mounted in a full color printer (bizhub PRESS (registered trademark) C1070, manufactured by Konica Minolta, Inc.). The full color printer includes a lubricant supply unit which is constituted by a solid lubricant and a lubricant applying member constituted by a brush roller.

A durability test in which a vertically long cyan solid image having a coverage of 50% was continuously printed by 300,000 sheets in a landscape orientation on A4 paper in a low-temperature and low-humidity environment (LL environment) at 10° C. and 15% RH, was conducted to evaluate the wear resistance by using wear-down amounts of a film thickness of the protective layer which is the outermost layer of the photoreceptor before and after the durability test.

In detail, the film thickness of the protective layer was measured at ten points randomly in a portion where the film thickness is uniform (a distal end portion and a rear end portion of the application where the film thickness is not uniform were removed by preparing a film thickness profile), and an average value of measured values was considered as the film thickness of the protective layer. As a film thickness measuring device, an eddy current type film thickness measuring device “EDDY560C” (manufactured by HELMUT FISCHER GMB IL Corp.) was used, and a difference in film thickness of the protective layer before and after the durability test was calculated as a film thickness wear-down amount (μm), and evaluated in accordance with the following evaluation criteria. In the present evaluation, in a case where the film thickness wear-down amount of the protective layer is 2.0 μm or less, that is, in a case of the following evaluations A and B, the film thickness wear-down amount is allowable in practice:

A: the film thickness wear-down amount is 1.0 μm or less (allowable in practice)

B: the film thickness wear-down amount is more than 1.0 μm and 2.0 μm or less (allowable in practice)

C: the film thickness wear-down amount is more than 2.0 μm and 3.0 μm or less (not allowable in practice)

D: the film thickness wear-down amount is more than 3.0 μm (not allowable in practice).

### <Cleanability>

Each photoreceptor obtained as described above was mounted in a full color printer (bizhub PRESS (registered trademark) C1070, manufactured by Konica Minolta, Inc.). As described above, the full color printer includes a lubricant supply unit which is constituted by a solid lubricant and a lubricant applying member constituted by a brush roller.

A durability test, in which a vertically long cyan solid image having a coverage of 50% was continuously printed by 300,000 sheets in a landscape orientation on A4 paper in a low-temperature and low-humidity environment (LL environment) at 10° C. and 15% RH, was conducted to evaluate cleanability (initial stage cleanability) before the durability test is conducted and cleanability (cleanability after the durability test) after the durability test is conducted.

In detail, a vertically long cyan solid image having a coverage of 50% was continuously printed by 5,000 sheets in a portrait orientation on A4 paper in a low-temperature and low-humidity environment (temperature of 10° C. and humidity of 15% RH) by using a photoreceptor and a cleaning blade, and then a full-surface halftone image was printed and observed with naked eyes (initial stage cleanability).

Thereafter, a durability test in which a vertically long cyan solid image having a coverage of 50% was continuously printed by 300,000 sheets in a portrait orientation on A4 paper in a low-temperature and low-humidity environment (LL environment) at 10° C. and 15% RH, was conducted. After the durability test, a vertically long cyan solid image having a coverage of 50% was continuously printed by 5,000 sheets in a portrait orientation on A4 paper in a low-temperature and low-humidity environment (temperature of 10° C. and relative humidity of 15% RH), and then a full-surface halftone image was printed and observed with naked eyes (cleanability after the durability test).

The initial stage cleanability and the cleanability after the durability test were evaluated in accordance with the following evaluation criteria. In a case of the following evaluations A and B, the cleanability is allowable in practice:

A: there is no unwiped portion on the entire surface (allowable in practice)

B: generation of chipping does not affect the image (allowable in practice)

C: There is an unwiped portion only on a blade chipping portion, which affects the image (not allowable in practice)

D: There is an unwiped portion on the entire surface, which affects the image (not allowable in practice).

### <Fogging>

The photoreceptor after the durability test is completed was mounted in a full color printer (bizhub PRESS (registered trademark) C1070, manufactured by Konica Minolta, Inc.). A white solid image was printed by 20 sheets in a low-temperature and low-humidity environment (LL environment) at 10° C. and 15% RH, and a twentieth image was scanned by a scanner. The scanned image was read into image editing software “Adobe Photoshop (registered trademark) CS6” (manufactured by Adobe Inc.), and converted into a monochrome image. Then, a black ratio of the scanned image was calculated by using the same software. The black ratio was evaluated as a blackening ratio, and a value averaged over 10 points was adopted. Here, a portion of a white background portion, on which the toner is printed, is recognized as being black. The blackening ratio represents an area ratio of black portions in the image, and a blackening ratio of a black solid image is 100%, and a blackening ratio of white paper is 0%. In a case where the blackening ratio is less than 0.15%, that is, in a case of the following evaluations A and B, the blackening ratio is allowable in practice:

A: the blackening ratio is less than 0.05% (allowable in practice)

B: the blackening ratio is 0.05% or more and less than 0.15% (allowable in practice)

C: the blackening ratio is 0.15% or more and less than 0.3% (not allowable in practice)

D: the blackening ratio is 0.3% or more (not allowable in practice).

Composition and evaluation results of the photoreceptor are shown in the following Table 2. It should be noted that in the following Table 2, the column of “kind of silicone” represents a kind of the surface treating agent (silicone surface treating agent) having a silicone chain as a side chain, and the column of “kind of reactive” represents a kind of the surface treating agent (reactive surface treating agent) having a polymerizable group.

TABLE 2

| | | First Conductive Metal Oxide Particle (D1) | | | | | Second Conductive Metal Oxide Particle (D2) | |
|---|---|---|---|---|---|---|---|---|
| | | (Surface-Treated Particle) | | | | | (Surface-Treated Particle) | |
| | | | Kind of | | Kind of | Kind of | | Kind of |
| | Photoreceptor No. | No. | Untreated | d1 | Silicone | Reactive | No. | Untreated |
| Example 1 | Photoreceptor 1 | 4 | SnO₂ | 20 nm | — | KBM-503 | 1 | SnO₂ |
| Example 2 | Photoreceptor 2 | 3 | SnO₂ | 20 nm | KF-9908 | KBM-503 | 2 | SnO₂ |
| Example 3 | Photoreceptor 3 | 3 | SnO₂ | 20 nm | KF-9908 | KBM-503 | 1 | SnO₂ |
| Example 4 | Photoreceptor 4 | 3 | SnO₂ | 20 nm | KF-9908 | KBM-503 | 7 | BaSO₄/SnO₂ |
| Example 5 | Photoreceptor 5 | 4 | SnO₂ | 20 nm | — | KBM-503 | 7 | BaSO₄/SnO₂ |
| Example 6 | Photoreceptor 6 | 19 | TiO₂ | 20 nm | — | KBM-503 | 7 | BaSO₄/SnO₂ |
| Example 7 | Photoreceptor 7 | 4 | SnO₂ | 20 nm | — | KBM-503 | 18 | TiO₂ |
| Example 8 | Photoreceptor 8 | 5 | SnO₂ | 30 nm | KF-9908 | KBM-503 | 7 | BaSO₄/SnO₂ |
| Example 9 | Photoreceptor 9 | 6 | SnO₂ | 10 nm | KF-9908 | KBM-503 | 7 | BaSO₄/SnO₂ |
| Example 10 | Photoreceptor 10 | 4 | SnO₂ | 20 nm | — | KBM-503 | 10 | BaSO₄/SnO₂ |
| Example 11 | Photoreceptor 11 | 4 | SnO₂ | 20 nm | — | KBM-503 | 13 | BaSO₄/SnO₂ |
| Example 12 | Photoreceptor 12 | 4 | SnO₂ | 20 nm | — | KBM-503 | 7 | BaSO₄/SnO₂ |
| Example 13 | Photoreceptor 13 | 4 | SnO₂ | 20 nm | — | KBM-503 | 15 | BaSO₄/SnO₂ |
| Example 14 | Photoreceptor 14 | 4 | SnO₂ | 20 nm | — | KBM-503 | 9 | BaSO₄/SnO₂ |
| Example 15 | Photoreceptor 15 | 4 | SnO₂ | 20 nm | — | KBM-503 | 11 | BaSO₄/SnO₂ |
| Example 16 | Photoreceptor 16 | 4 | SnO₂ | 20 nm | — | KBM-503 | 12 | BaSO₄/SnO₂ |
| Example 17 | Photoreceptor 17 | 4 | SnO₂ | 20 nm | — | KBM-503 | 14 | BaSO₄/SnO₂ |
| Comparative | Comparative | 6 | SnO₂ | 10 nm | KF-9908 | KBM-503 | — | — |
| Example 1 | Photoreceptor 1 | | | | | | | |
| Comparative | Comparative | — | — | — | — | — | 7 | BaSO₄/SnO₂ |
| Example 2 | Photoreceptor 2 | | | | | | | |
| Comparative | Comparative | 4 | SnO₂ | 20 nm | — | KBM-503 | 8 | BaSO₄/SnO₂ |
| Example 3 | Photoreceptor 3 | | | | | | | |
| Comparative | Comparative | 4 | SnO₂ | 20 nm | — | KBM-503 | — | BaSO₄/SnO₂ |
| Example 4 | Photoreceptor 4 | | | | | | | |
| Comparative | Comparative | — | — | — | — | — | 8 | BaSO₄/SnO₂ |
| Example 5 | Photoreceptor 5 | | | | | | | |
| Comparative | Comparative | 4 | SnO₂ | 20 nm | — | KBM-503 | 16 | BaSO₄/SnO₂ |
| Example 6 | Photoreceptor 6 | | | | | | | |
| Comparative | Comparative | 4 | SnO₂ | 20 nm | — | KBM-503 | 17 | BaSO₄/SnO₂ |
| Example 7 | Photoreceptor 7 | | | | | | | |

| | | | | Evaluation | | | |
|---|---|---|---|---|---|---|---|
| | Second Conductive Metal Oxide Particle (D2) | | | | Cleanability | | |
| | (Surface-Treated Particle) | | | | | After | |
| | | Kind of | Kind of | Wear | Initial | Durability | |
| | d2 | Silicone | Reactive | Resistance | Stage | Test | Fogging |
| Example 1 | 100 nm | KF-9908 | KBM-503 | A | A | B | B |
| Example 2 | 100 nm | — | KBM-503 | B | B | B | A |
| Example 3 | 100 nm | KF-9908 | KBM-503 | B | A | B | A |
| Example 4 | 100 nm | KF-9908 | KBM-503 | A | A | A | A |
| Example 5 | 100 nm | KF-9908 | KBM-503 | A | A | A | B |
| Example 6 | 100 nm | KF-9908 | KBM-503 | B | A | B | A |
| Example 7 | 100 nm | KF-9908 | KBM-503 | B | B | B | B |
| Example 8 | 100 nm | KF-9908 | KBM-503 | A | A | B | A |
| Example 9 | 100 nm | KF-9908 | KBM-503 | A | A | A | B |
| Example 10 | 50 nm | KF-9908 | KBM-503 | B | B | A | B |
| Example 11 | 500 nm | KF-9908 | KBM-503 | A | A | B | A |
| Example 12 | 100 nm | KF-9908 | KBM-503 | A | A | A | B |
| Example 13 | 100 nm | KP-578 | KBM-503 | B | B | B | B |
| Example 14 | 100 nm | KF-9908 | — | B | A | B | B |
| Example 15 | 45 nm | KF-9908 | KBM-503 | B | B | A | B |
| Example 16 | 35 nm | KF-9908 | KBM-503 | B | B | B | B |
| Example 17 | 600 nm | KF-9908 | KBM-503 | A | B | B | A |
| Comparative | — | — | — | C | C | A | C |
| Example 1 | | | | | | | |
| Comparative | 100 nm | KF-9908 | KBM-503 | A | A | C | A |
| Example 2 | | | | | | | |
| Comparative | 100 nm | — | KBM-503 | C | B | C | C |
| Example 3 | | | | | | | |
| Comparative | — | — | — | D | D | D | D |
| Example 4 | | | | | | | |
| Comparative | 100 nm | — | KBM-503 | B | B | D | B |
| Example 5 | | | | | | | |
| Comparative | 100 nm | Novec | KBM-503 | C | B | D | D |
| Example 6 | | | | | | | |
| Comparative | 100 nm | KF-9901 | KBM-503 | B | B | C | B |
| Example 7 | | | | | | | |

As apparent from Table 2 above, it was found that the photoreceptors of Examples have excellent wear resistance and cleanability and the fogging is also suppressed. Meanwhile, it was found that in a case of the photoreceptors of Comparative Examples, at least one of wear resistance, cleanability, and a level of fogging does not reach an allowable level in practice.

Although embodiments of the present invention have been described in detail, the disclosed embodiments are made for the purpose of example only and not limitation. The scope of the present invention should be interpreted by terms of the appended claims.

What is claimed is:

1. An electrophotographic photoreceptor which is used in an image forming method, the image forming method including:
a charging process of charging a surface of the electrophotographic photoreceptor,
an exposing process of exposing the charged electrophotographic photoreceptor to form an electrostatic latent image,
a developing process of supplying a toner to the electrophotographic photoreceptor on which the electrostatic latent image is formed to form a toner image,
a transfer process of transferring the toner image formed on the electrophotographic photoreceptor,
a lubricant supply process of supplying a lubricant to the surface of the electrophotographic photoreceptor; and
a cleaning process of removing the toner remaining on the surface of the electrophotographic photoreceptor,
the electrophotographic photoreceptor comprising:
a conductive support; a photosensitive layer disposed on the conductive support; and an outermost layer disposed on the photosensitive layer,
wherein the outermost layer includes a cured product of a composition containing a polymerizable monomer and two or more kinds of conductive metal oxide particles having different number average primary particle diameters from each other, and
at least one of the two or more kinds of conductive metal oxide particles is surface-treated with a surface treating agent having a silicone chain as a side chain.

2. The electrophotographic photoreceptor according to claim 1, wherein when a number average primary particle diameter of first conductive metal oxide particles (D1) having the smallest number average primary particle diameter is d1, and a number average primary particle diameter of second conductive metal oxide particles (D2) having the largest number average primary particle diameter is d2, the first conductive metal oxide particles and the second conductive metal oxide particles being included in the two or more kinds of conductive metal oxide particles, a ratio of d1 to d2 (d1/d2) satisfies the following Expression 1.
[Math 1]
0<d1/d2≤0.5 (1)

3. The electrophotographic photoreceptor according to claim 2, wherein d1 is 5 nm or more and less than 50 nm and d2 is 50 nm or more and 500 nm or less.

4. The electrophotographic photoreceptor according to claim 2, wherein at least the second conductive metal oxide particle (D2) is surface-treated with the surface treating agent having a silicone chain as a side chain.

5. The electrophotographic photoreceptor according to claim 2, wherein the second conductive metal oxide particle is a particle having a core-shell structure including a core and a shell formed of a conductive metal oxide.

6. The electrophotographic photoreceptor according to claim 1, wherein the conductive metal oxide particle surface-treated with the surface treating agent having a silicone chain as a side chain has a group derived from a polymerizable group.

7. The electrophotographic photoreceptor according to claim 1, wherein the surface treating agent having a silicone chain as a side chain has a poly(meth)acrylate main chain or a silicone main chain.

8. An image forming method comprising:
a charging process of charging a surface of an electrophotographic photoreceptor;
an exposing process of exposing the charged electrophotographic photoreceptor to form an electrostatic latent image;
a developing process of supplying a toner to the exposed electrophotographic photoreceptor to form a toner image;
a transfer process of transferring the toner image formed on the electrophotographic photoreceptor;
a lubricant supply process of supplying a lubricant to the surface of the electrophotographic photoreceptor; and
a cleaning process of removing the toner remaining on the surface of the electrophotographic photoreceptor,
wherein the electrophotographic photoreceptor is the electrophotographic photoreceptor according to claim 1.

9. An image forming apparatus comprising:
an electrophotographic photoreceptor;
a charging unit which charges a surface of the electrophotographic photoreceptor;
an exposing unit which exposes the charged electrophotographic photoreceptor to form an electrostatic latent image;
a developing unit which supplies a toner to the electrophotographic photoreceptor on which the electrostatic latent image is formed to form a toner image;
a lubricant supply unit which supplies a lubricant to the surface of the electrophotographic photoreceptor;
a transfer unit which transfers the toner image formed on the electrophotographic photoreceptor; and
a cleaning unit which removes the toner remaining on the surface of the electrophotographic photoreceptor,
wherein the electrophotographic photoreceptor is the electrophotographic photoreceptor according to claim 1.
